(19) United States
(12) Patent Application Publication
(10) Pub. No.: US 2026/0289109 A1
(43) Pub. Date: Sep. 24, 2026

(54) SYSTEM

(71) Applicant: SoftBank Group Corp., Tokyo (JP)

(72) Inventor: Yoshifumi KISHI, Tokyo (JP)

(73) Assignee: SoftBank Group Corp., Tokyo (JP)

(21) Appl. No.: 19/564,834

(22) Filed: Mar. 12, 2026

(30) Foreign Application Priority Data
Mar. 19, 2025 (JP) 2025-045040

(51) Int. Cl. G06F 40/205; G06N 3/0475

(52) U.S. Cl. CPC G06F 40/205; G06N 3/0475

(57) ABSTRACT

A system includes a processor that is configured to monitor sensor data and log data to detect an abnormal event when the abnormal event occurs, analyze an inquiry from a user by using a natural language processing technique and generate a prompt for instructing a generative AI model to generate a response, and cause the generative AI model to generate the response based on the generated prompt.

### CROSS-REFERENCE TO RELATED APPLICATION

This application is based on and claims priority under 35 USC 119 from Japanese Patent Application No. 2025-045040 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional incident response and customer support systems in financial technology and other critical infrastructures suffer from several limitations. First, incident detection based on sensor data and log data is often performed manually or by simple threshold-based monitoring, which leads to delayed recognition of abnormal events, insufficient characterization of incident context, and high operational burden on human operators. Second, user inquiries related to such incidents are typically processed by human agents or by rigid rule-based chatbots that cannot flexibly understand natural language expressions, resulting in slow, inconsistent, or inappropriate responses and reduced user satisfaction. Third, even when advanced generative AI models are available, there is no integrated mechanism that automatically connects real-time incident detection with natural language analysis of user inquiries and precise prompt generation for the generative AI model, so the full potential of generative AI in incident handling and customer support is not realized. Accordingly, there is a need for a system that can automatically and in real time detect abnormal events from sensor data and log data, can understand user inquiries in natural language, can generate prompts suitable for instructing a generative AI model, and can thereby cause the generative AI model to generate appropriate responses with reduced human intervention.

### SUMMARY

In order to solve the above-described problems, a system according to one embodiment of the present invention comprises a processor configured to monitor sensor data and log data to detect an abnormal event when the abnormal event occurs, analyze an inquiry from a user by using a natural language processing technique, and generate a prompt for instructing a generative AI model to generate a response. The processor is further configured to cause the generative AI model to generate the response based on the generated prompt. In one aspect, the processor monitors the sensor data and the log data in real time, detects an abnormal pattern in the sensor data or the log data, and automatically notifies related information by using an analysis capability of artificial intelligence, thereby enabling rapid and automated incident detection and notification. In another aspect, the processor analyzes content of the inquiry from the user by using the natural language processing technique and the generative AI model, generates the prompt for instructing the generative AI model to generate the response based on an analysis result, and automatically generates an appropriate response based on the prompt, thereby enabling flexible and accurate automated responses to user inquiries that are aligned with the current incident status and user context.

The term “processor” refers to a hardware circuit, such as a central processing unit (CPU), a microprocessor, a microcontroller, a digital signal processor, a graphics processing unit, or any combination thereof, that is configured to execute instructions to perform the functions described in the present specification and claims.

The term “sensor data” refers to data acquired from one or more physical or virtual sensors, including but not limited to temperature sensors, pressure sensors, network traffic sensors, performance counters, application metrics collectors, or monitoring agents, which provide measurements or observations of states or behaviors of a system, device, or environment.

The term “log data” refers to data recorded by hardware or software components in the form of logs, including but not limited to application logs, system logs, security logs, transaction logs, event logs, and audit logs, which describe events, operations, errors, or status information of the system.

The term “abnormal event” refers to an event or condition that deviates from an expected or normal operating state of a system, as determined by rules, thresholds, statistical analysis, machine learning, or other algorithms, and that may indicate a failure, degradation, security incident, or other undesired behavior.

The term “inquiry” refers to a message, question, complaint, request for information, or other communication transmitted by a user to the system, in natural language or semi-structured form, via communication channels such as email, web forms, chat interfaces, or mobile applications.

The term “user” refers to a human individual or an entity, such as a customer, operator, or administrator, that interacts with the system by sending inquiries, receiving responses, or otherwise using services provided by the system.

The term “natural language processing technique” refers to any algorithm, method, or model that processes or analyzes human language expressed in text or speech, including but not limited to tokenization, part-of-speech tagging, parsing, named entity recognition, intent detection, sentiment analysis, and language understanding models such as machine learning or deep learning models.

The term “generative AI model” refers to an artificial intelligence model that is capable of generating new content based on input data or prompts, including but not limited to large language models, sequence-to-sequence models, transformer-based models, or other generative models that can produce natural language text, summaries, or answers.

The term “prompt” refers to data, including text or structured information, generated by the processor and provided as input to the generative AI model, which specifies or constrains how the generative AI model should generate a response, including instructions, context, user information, incident information, or other control parameters.

The term “response” refers to an output generated by the generative AI model based on a prompt, including but not limited to an answer to a user inquiry, an explanation of an incident, troubleshooting instructions, status information, or any other natural language message intended to be communicated to the user or to another system.

The term “real time” refers to operation of the system with a latency that is sufficiently short to allow the system to detect abnormal patterns and generate notifications or responses without substantial delay relative to the occurrence of underlying events, within time constraints required by the target application.

The term “abnormal pattern” refers to a pattern or combination of features in sensor data or log data, such as frequency, sequence, magnitude, or correlation of events, that deviates from a normal pattern learned or defined for the system and is indicative of an abnormal event.

The term “analysis capability of artificial intelligence” refers to the ability of an artificial intelligence model or algorithm, including machine learning or deep learning models, to process data, identify patterns, infer relationships, classify events, or extract information in order to support detection of abnormal events, generation of notifications, or selection of relevant related information.

The term “related information” refers to information associated with an abnormal event or user inquiry, including but not limited to timestamps, affected services, error codes, system status, possible causes, impact scope, recommended actions, and references to incident records, which is useful for operators or users in understanding or addressing the event.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

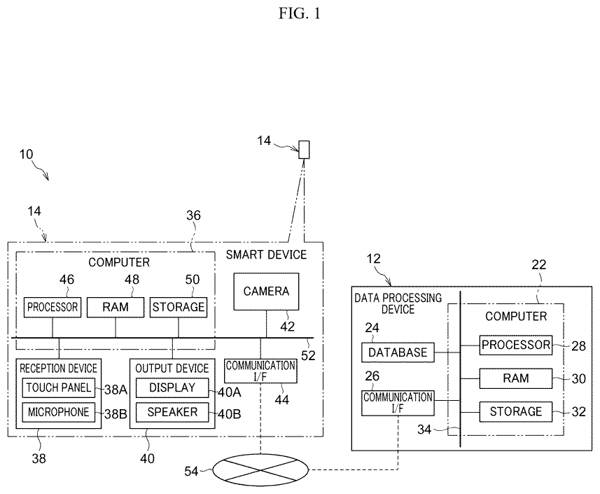

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

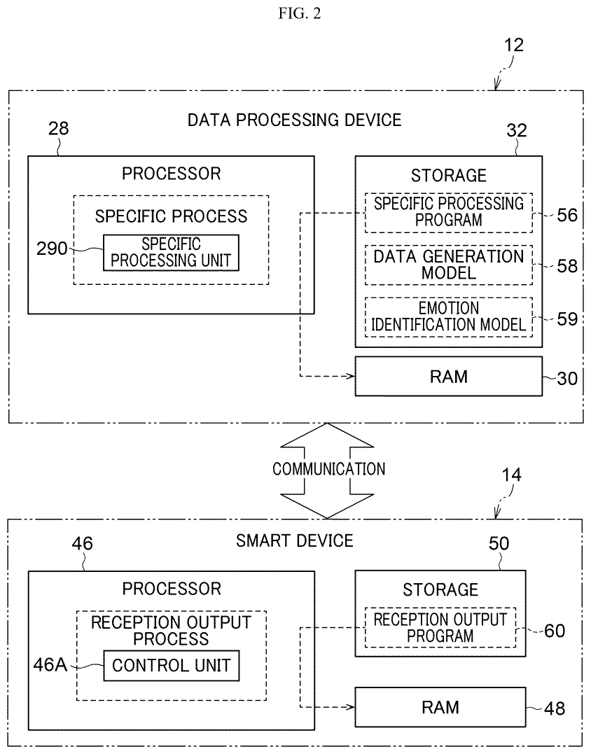

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional incident management and customer support systems in information processing environments treat anomaly detection, log analysis, and user inquiry handling as separate processing flows that are only loosely integrated, and typically rely on static rule engines, fixed templates, and manually crafted responses. As a result, such systems are limited in their ability to (i) interpret heterogeneous operation information such as sensor data, log records, and transaction records in a unified manner, (ii) dynamically generate context-aware natural language explanations and reports for abnormal events, and (iii) adapt the quality of automated responses over time based on explicit feedback. In particular, existing systems generally do not use generative artificial intelligence models as first-class components of the incident-processing pipeline, and therefore cannot effectively use prompt sentences that encode structured operational context, user intent, urgency, and knowledge base content in order to improve both machine understanding and generated responses. From a computer-technology perspective, this fragmented architecture causes inefficiencies and technical limitations. First, processing units must execute multiple independent modules for monitoring, analysis, notification, and response generation, which increases redundancy in data parsing, feature extraction, and state management. This leads to increased processor load and memory consumption, as the same operation information is repeatedly transformed and filtered for each subsystem. Second, because prompts and responses are not treated as structured processing artifacts that are iteratively optimized, the system cannot systematically learn from prior interactions, which results in suboptimal use of computational resources of the generative artificial intelligence model and restricts scalability when handling a large volume of abnormal events and user inquiries. Third, the lack of an integrated prompt-management mechanism prevents the system from consistently combining time-series information, integrated multi-source operation information, and knowledge information into a single instruction to the generative artificial intelligence model, thereby limiting the accuracy and stability of anomaly explanation, root cause analysis, and recurrence prevention proposals.

Therefore, there is a need for an improved computer-implemented system and server architecture that (i) continuously monitors and structures operation information, (ii) generates and refines multiple types of prompt sentences tailored to different processing stages, (iii) controls a generative artificial intelligence model to produce explanation information, user response information, and report information in an integrated manner, and (iv) updates such prompt sentences based on evaluation information so as to improve the overall technical performance and adaptability of incident detection, analysis, and response generation in information processing apparatuses.

The specific processing by the specific processing unit 290 of the data processing device 12 in Example 1 is realized by the following means.

The present invention provides a server comprising a processor configured to monitor operation information including observation information and transaction information acquired in an information processing apparatus, generate statistical information and event information from the operation information, detect an abnormal event based on the statistical information and the event information, generate, based on a detection result of the abnormal event and the operation information, a first prompt sentence for instructing a generative artificial intelligence model to generate summary information and hypothesis information regarding the abnormal event, control the generative artificial intelligence model to generate explanation information regarding the abnormal event based on the first prompt sentence, analyze inquiry information in natural language acquired from a user apparatus by using a language processing algorithm, extract inquiry intention information and urgency information, generate a response generation prompt sentence including the inquiry information, the inquiry intention information, and the urgency information, acquire related rule information and guidance information from a knowledge information storage apparatus according to the inquiry intention information and the urgency information, add the related rule information and the guidance information to the response generation prompt sentence, control the generative artificial intelligence model to generate user response information based on the response generation prompt sentence, generate and transmit notification information to a staff apparatus based on the detection result of the abnormal event, distribute the explanation information and the user response information to the staff apparatus and the user apparatus, aggregate the operation information and the explanation information regarding past abnormal events, generate a report generation prompt sentence for input to the generative artificial intelligence model, control the generative artificial intelligence model to generate report information including recurrence prevention measure information based on the report generation prompt sentence, acquire evaluation information regarding at least one of the inquiry information, the user response information, and the report information, and update contents of the first prompt sentence and the response generation prompt sentence based on the evaluation information. This enables the server to implement, in a single integrated processing pipeline, adaptive prompt-driven control of the generative artificial intelligence model over heterogeneous operation information and user interactions, thereby improving the efficiency and accuracy of abnormal event detection, explanation generation, user response generation, and post-incident reporting in the information processing apparatus, while reducing redundant processing and allowing continuous refinement of prompts and model behavior based on collected evaluation information.

The term “operation information” refers to information indicating a state, behavior, or result of execution of at least one processing component in an information processing apparatus, and includes, but is not limited to, observation information, transaction information, log information, and performance information that are generated or acquired during operation of hardware resources or software resources.

The term “observation information” refers to information obtained from one or more sensing functions of an information processing environment, and includes, but is not limited to, sensor readings, monitoring metrics, and environmental measurements that indicate operational conditions of physical or virtual components.

The term “transaction information” refers to information representing execution of a logical operation involving at least one request and at least one response between processing components, and includes, but is not limited to, financial transaction records, service invocation records, and application-level request/response histories.

The term “statistical information” refers to information generated by applying at least one statistical operation to operation information, and includes, but is not limited to, aggregated counts, averages, distributions, rates, and correlation values computed over a predetermined period or data set.

The term “event information” refers to information representing occurrence of a particular condition or state transition derived from operation information, and includes, but is not limited to, detection of error codes, threshold crossings, state changes, and pattern matches indicating noteworthy system behavior.

The term “abnormal event” refers to an event that deviates from a normal operating state of an information processing apparatus, and includes, but is not limited to, failures, performance degradations, security incidents, and anomalous patterns in operation information that satisfy predetermined abnormality criteria.

The term “detection result of the abnormal event” refers to information indicating that an abnormal event has been identified, and includes, but is not limited to, a type of abnormal event, a detection time, a severity level, and identifiers of affected components.

The term “generative artificial intelligence model” refers to a data processing model that has been trained using machine learning techniques to generate output data, including natural language text, based on input data, and that is capable of producing new sequences or content not explicitly stored in advance.

The term “prompt sentence” refers to a data structure including at least one natural language expression or structured instruction that is provided as input to a generative artificial intelligence model to condition or control generation of output data by the model.

The term “first prompt sentence” refers to a prompt sentence that includes at least information related to an abnormal event and operation information, and that is configured to instruct a generative artificial intelligence model to generate summary information and hypothesis information regarding the abnormal event.

The term “response generation prompt sentence” refers to a prompt sentence that includes at least inquiry information, inquiry intention information, and urgency information, and optionally knowledge information, and that is configured to instruct a generative artificial intelligence model to generate user response information.

The term “report generation prompt sentence” refers to a prompt sentence that includes at least operation information and explanation information related to one or more past abnormal events, and that is configured to instruct a generative artificial intelligence model to generate report information including recurrence prevention measure information.

The term “analysis prompt sentence” refers to a prompt sentence that includes at least time-series information and integrated information generated from operation information, and that is configured to instruct a generative artificial intelligence model to generate analysis result information including cause candidate information and influence range information regarding an abnormal event.

The term “dialogue prompt sentence” refers to a prompt sentence that includes at least one of inquiry information and explanation information selected in response to operation information input from a user apparatus, and that is configured to instruct a generative artificial intelligence model to generate dialogue response information for interactive communication.

The term “summary information” refers to information that concisely describes characteristics of an abnormal event, and includes, but is not limited to, a natural language explanation indicating an overview of the abnormal event, affected components, and principal symptoms.

The term “hypothesis information” refers to information indicating one or more possible causes or contributing factors of an abnormal event inferred from operation information, and includes, but is not limited to, candidate root causes, suspected failure points, and contextual conditions.

The term “explanation information” refers to information generated by a generative artificial intelligence model that provides a human-readable description of at least one abnormal event, and may include summary information, hypothesis information, and analysis result information in a structured or unstructured form.

The term “inquiry information” refers to information representing a request, complaint, or question input by a user via a user apparatus, and includes, but is not limited to, natural language text expressing an issue or demand regarding operation of an information processing apparatus or service.

The term “inquiry intention information” refers to information indicating a classified purpose or category of inquiry information, and includes, but is not limited to, labels representing types of issues, requested operations, or subject matters derived from analysis of the inquiry information.

The term “urgency information” refers to information indicating a degree of urgency or priority associated with handling of inquiry information or an abnormal event, and includes, but is not limited to, a level classification or score representing how quickly a response or action is requested.

The term “user response information” refers to information generated by a generative artificial intelligence model as a response to inquiry information, and includes, but is not limited to, natural language instructions, explanations, or guidance to be presented to a user via a user apparatus.

The term “rule information” refers to information representing at least one rule, policy, or constraint related to operation of a system or service, and includes, but is not limited to, terms, conditions, operational procedures, and compliance requirements stored in a knowledge information storage apparatus.

The term “guidance information” refers to information representing at least one procedure or recommendation for handling an event or inquiry, and includes, but is not limited to, step-by-step instructions, troubleshooting steps, and operational advice.

The term “knowledge information storage apparatus” refers to a storage mechanism configured to hold rule information, guidance information, and other reference information used by an information processing system, and includes, but is not limited to, a database apparatus, a file storage apparatus, or a document management apparatus.

The term “notification information” refers to information that is generated for the purpose of informing at least one staff apparatus of an abnormal event or a related status, and includes, but is not limited to, alert messages, incident summaries, and escalation notices transmitted via a communication network.

The term “staff apparatus” refers to an information processing terminal operated by personnel responsible for system operation, maintenance, or support, and includes, but is not limited to, a workstation, a portable terminal, or a communication terminal capable of receiving notification information and explanation information.

The term “user apparatus” refers to an information processing terminal operated by an end user of a service, and includes, but is not limited to, a client terminal, a mobile terminal, or a web-access device that can transmit inquiry information and receive user response information.

The term “report information” refers to information generated by a generative artificial intelligence model based on a report generation prompt sentence, and includes, but is not limited to, a post-incident report describing abnormal events, their causes, impacts, and recurrence prevention measures.

The term “recurrence prevention measure information” refers to information indicating one or more specific actions or modifications to be implemented in order to reduce a likelihood of reoccurrence of an abnormal event, and includes, but is not limited to, configuration changes, software modifications, and operational procedure adjustments.

The term “evaluation information” refers to information representing an assessment or feedback regarding at least one of inquiry information, user response information, explanation information, and report information, and includes, but is not limited to, user ratings, operator comments, and automatically derived performance indicators.

The term “time-series information” refers to information generated by arranging or aggregating operation information along a temporal axis, and includes, but is not limited to, sequences of measurement values, event counts per unit time, and chronological histories of state changes.

The term “integrated information” refers to information generated by combining a plurality of types of operation information obtained from a plurality of recording sources into a unified representation, and includes, but is not limited to, merged records, joined tables, or composite features.

The term “analysis result information” refers to information generated based on processing of operation information by a generative artificial intelligence model and other algorithms, and includes, but is not limited to, cause candidate information, influence range information, and structured diagnostic outputs.

The term “cause candidate information” refers to information indicating one or more potential causes or factors that may have contributed to occurrence of an abnormal event, and includes, but is not limited to, identified components, configurations, or operations suspected as sources of the abnormal event.

The term “influence range information” refers to information indicating a scope of impact of an abnormal event, and includes, but is not limited to, affected components, affected users, affected time intervals, and affected functional areas.

The term “dialogue response information” refers to information generated by a generative artificial intelligence model in response to a dialogue prompt sentence, and includes, but is not limited to, natural language utterances suitable for interactive communication with a user regarding an abnormal event or inquiry.

In the following embodiments, the same reference concept may be applied to multiple configurations. The embodiments are illustrative and do not limit the scope of the claims.

Server, terminal, and user cooperate through a network to implement an incident management and inquiry response system that uses a generative AI model controlled by structured prompt sentences. Server executes most of the data processing and model interaction. Terminal provides user-facing interfaces. User operates terminal to view information and input inquiries or prompt sentences.

Server is implemented by one or more information processing devices. In one embodiment, server runs on a general-purpose computer platform, such as a rack-mounted server with a multi-core central processing unit (CPU) (for example, an x86-compatible processor), a main memory, a nonvolatile storage device such as a solid-state drive, and a network interface card connected to a packet-based communication network. Server may additionally comprise one or more graphics processing units (GPUs) configured to accelerate matrix operations for a generative AI model. Server executes an operating system such as a general-purpose server operating system and application software including a web application framework, a database management system, and a model inference engine.

Terminal is implemented by a client information processing device, such as a mobile communication terminal, a portable information terminal, or a desktop computer. Terminal comprises a processor, a memory, a display unit, an input unit such as a touch panel or keyboard, and a communication interface. Terminal executes a web browser or a dedicated application program to access server via a network.

User is an operator of terminal. User may be a maintenance staff member, an operations engineer, or an end user of a service. User invokes functions of the system by operating terminal.

### 1. Hardware and Software Configuration

Server executes a monitoring module, a log aggregation module, a feature extraction module, a prompt management module, a generative AI model interface module, a knowledge retrieval module, a notification module, a dashboard backend module, and a feedback analysis module.

Server uses log collection software, such as an agent process that reads log files from application components and transmits log entries to server. Server stores operation information, including observation information and transaction information, in a structured data repository such as a relational database or a time-series database. Server may additionally store detailed log messages in a search index engine.

Server uses a model inference engine, such as a deep learning framework, to execute a generative AI model. In one embodiment, the generative AI model is a transformer-based neural network having multiple self-attention layers and feedforward layers. The generative AI model receives a prompt sentence as a sequence of tokens and outputs a probability distribution over output tokens at each decoding step. Server executes the model on GPUs to reduce processing time.

Terminal executes a client module that presents a graphical user interface. Terminal renders chat-style views for inquiry input and response display, and tabular or card-based views for incident summaries and analysis results.

User views incident information and generated explanations on terminal, and inputs inquiries and prompt sentences through text fields or selection widgets.

### 2. Operation Information Structuring and Feature Extraction

Server acquires operation information from sensors, application logs, and transaction processing components. Operation information includes timestamps, identifiers of processing components, transaction identifiers, response codes, latency values, resource usage metrics, and error codes.

Server transforms raw text logs into structured records. Server parses log entries using text parsing algorithms such as regular expression matching and tokenization. Server extracts fields such as “time”, “service_name”, “request_path”, “status_code”, “error_code”, and “user_identifier”. Server stores the extracted fields in database tables. This data structuring reduces the need for repeated parsing and allows efficient computation of statistical information.

Server computes statistical information by applying aggregation operations to the structured operation information. For example, server computes a count of error codes per minute, an average response time for each endpoint, a distribution of response codes per service, and correlation measures between resource usage and error frequency. Server computes these values by executing aggregation queries over the database or by using in-memory computation frameworks. Server stores statistical information in a separate table or in a time-series data store.

Server also generates event information by applying rule-based and pattern-based algorithms. For example, server detects an event when the error count for a particular endpoint exceeds a threshold within a sliding time window, when a ratio of failed transactions exceeds a predefined percentage, or when a combination of error codes occurs in a specific sequence. Server represents each event by an event record having fields for type, time interval, affected resource, and summary text.

This structuring and feature extraction reduces redundant computation in downstream modules and provides compact context that can be embedded into prompt sentences. Because the generative AI model receives a summarized representation of operation information instead of raw logs, the system improves computational efficiency and reduces memory bandwidth usage.

### 3. Generative AI Model Architecture and Training

Server implements the generative AI model as a sequence-to-sequence neural network with a transformer architecture. The model comprises an embedding layer that maps each token to a continuous vector, a stack of encoder layers, and a stack of decoder layers. Each encoder layer includes a multi-head self-attention sublayer and a position-wise feedforward sublayer.

Each decoder layer includes a masked self-attention sublayer, an encoder-decoder attention sublayer, and a feedforward sublayer.

Server trains or fine-tunes the generative AI model using supervised learning. Server provides pairs of input prompt sentences and target output texts. For abnormal events, server uses historical incident summaries and root cause analyses as target outputs. For user responses, server uses previously approved support messages and FAQ answers. For reports, server uses past post-incident reports. Server defines a loss function, such as a cross-entropy loss between predicted token distributions and ground-truth tokens. Server updates model weights by gradient-based optimization, such as stochastic gradient descent or an adaptive moment estimation method.

Server may perform data augmentation by rewriting historical incident descriptions or paraphrasing user inquiries. Server may also generate synthetic training prompts by combining structured operation information with randomly sampled templates. This training procedure results in a model that is specialized for interpreting structured technical context embedded in prompt sentences.

Server stores learned model parameters in a storage device and loads the parameters into GPU memory for inference. Server may quantize model weights or compress attention representations to reduce memory usage and inference latency.

By specifying the model architecture, training method, and loss function, the system moves beyond abstract reference to “AI” and discloses concrete machine learning mechanisms that implement the claimed functions.

### 4. Prompt Sentence Generation and Structure

Server treats prompt sentences as primary data structures that carry both human-readable instructions and machine-readable context.

Server generates a first prompt sentence for abnormal events. Server constructs this prompt sentence by concatenating textual labels and structured values. For example, server may generate:
“System context:
Time window: 2026-01-30T10:12:00Z to 2026-01-30T10:17:00Z.
Service: authentication service.
Error code: AUTH-403.
Error count in window: 300 (normal baseline: 5 per 5 minutes).
Representative log messages:
1) 2026-01-30T10:13:02Z authentication ERROR AUTH-403 ‘Invalid token issuer’.
2) 2026-01-30T10:13:04Z authentication ERROR AUTH-403 ‘Token verification failed’.

### Task:

Summarize the abnormal event, propose likely causes, and classify severity as low, medium, or high.”

Server encodes structured fields into natural language sentences and inserts explicit task instructions. This structure allows the generative AI model to condition generation on both statistical features and explicit task requirements. The model uses internal attention mechanisms to relate tokens representing error codes, counts, and tasks.

Server generates a response generation prompt sentence for user inquiries. Server first analyzes inquiry information using a language processing algorithm, such as a classifier based on a smaller neural network or gradient-boosted decision trees. Server extracts inquiry intention information (for example, “login issue”) and urgency information (for example, “medium”). Server retrieves rule information and guidance information from a knowledge information storage apparatus by performing keyword search or vector similarity search over stored documents.

Server then composes a response generation prompt sentence, such as:

“You are a support assistant for an online financial service.

### User Inquiry:

‘I cannot log in to my account. It keeps showing an error message.’

Detected intent: login issue.

Detected urgency: medium.

### Relevant Policy:

1. Ask the user to try password reset.

2. If the issue persists, instruct the user to contact support with registered email.

### Task:

Generate a short, polite response to the user. Use simple language.”

Server provides this prompt sentence to the generative AI model. The model processes the sequence and generates user response information token by token.

Server generates a report generation prompt sentence after aggregating operation information and explanation information for past abnormal events. Server may create:

“Generate a post-incident report in English.

### Incident Summary:

[Summary text of abnormal event].

### Timeline:

[Chronological list of key events].

### Impact Metrics:

[Number of affected sessions, peak error rates].

### Existing Hypothesis:

[Hypothesis text].

### Task:

Describe root cause, impact, corrective actions, and recurrence prevention measures in structured paragraphs.”

By controlling the content and format of prompt sentences, server induces consistent structure in model outputs and improves downstream parsing and display. This structuring also reduces token length by focusing on relevant features, which improves computation efficiency and reduces network latency when calling remote model endpoints.

### 5. Distinction from Manual and Rule-Based Approaches

Server does not simply automate human drafting of messages. Instead, server implements non-conventional processing that integrates structured operation information, statistical information, and knowledge information into machine-optimized prompt sentences. Server uses the prompt sentences as an internal interface that coordinates multiple modules: monitoring, classification, retrieval, and generative modeling.

Server applies a feedback loop. Server acquires evaluation information, such as user ratings or staff annotations, for generated explanation information, user response information, and report information. Server analyzes evaluation information and modifies templates used for prompt sentences, such as by adjusting severity thresholds embedded in instructions, changing explanation length requirements, or adding constraints against ambiguous phrases. Server may also adjust hyperparameters of the generative AI model, such as temperature or maximum output length, based on evaluation statistics. This configuration yields a technical effect of gradual quality improvement in generated outputs without retraining the model for each change.

Unlike a simple rules engine, server uses the generative AI model to perform mapping from structured incident descriptions to coherent multi-sentence explanations and procedural recommendations. Server relies on the model's learned internal representations of language and technical patterns, which are shaped by the training procedure disclosed above. This improves coverage over unforeseen error combinations, because the model generalizes from learned patterns rather than matching only predefined templates.

### 6. Data Flow and Internal Modules

Server implements a modular data flow.

Server first receives raw operation information. Server stores this in an append-only log table. Server then invokes a preprocessing module that normalizes timestamps, converts numeric values to standard units, and maps codes to canonical forms using a code dictionary. Server next invokes a feature computation module that calculates moving averages, standard deviations, and ratio metrics for specific fields. Server stores these derived features in a metrics table keyed by time and component. Server uses these features to detect abnormal events with rules that refer to statistical thresholds and rate-of-change conditions, such as “if error_rate_current>error_rate_baseline×factor and factor exceeds a threshold, then mark as abnormal.”

Server passes the detected abnormal events to a prompt generation module. The prompt generation module queries the metrics table and the event table to gather context for a specific abnormal event. The module applies a formatting algorithm that produces structured text segments, such as “metric_name: value (baseline: value).” The module concatenates segments and pre-defined instruction phrases into the first prompt sentence.

Server sends the first prompt sentence to the generative AI model interface module. The interface module tokenizes the sentence according to the model's vocabulary, forms a tensor representation, and sends it to the model inference engine running on GPU. The model outputs a sequence of token probabilities. The interface module applies a decoding algorithm, such as beam search or nucleus sampling, to produce explanation information.

Server stores explanation information in a persistent store associated with the abnormal event. Server indexes explanation information for fast retrieval by the dashboard backend module.

Server implements similar flows for handling inquiry information and report generation. In response flows, server integrates retrieved rule information and guidance information into the response generation prompt sentence. In report flows, server integrates multiple incidents' information over a period into the report generation prompt sentence.

### 7. Technical Effects and Improvements

Server improves processing speed by precomputing statistical information and event information, which allows quick generation of compact prompt sentences rather than feeding raw logs into the generative AI model. Server reduces the number of tokens processed by the model, which reduces inference time and resource consumption.

Server improves accuracy of incident explanation and response generation by encoding structured fields, such as error codes and severity classifications, into prompt sentences together with explicit tasks. Because the model is conditioned on more precise features, generated outputs more accurately reflect system state and recommended actions. This reduces misinterpretation compared to unstructured natural language prompts.

Server improves data management by using unified internal data structures for operation information, feature information, and evaluation information. Server identifies repeated patterns of abnormal events and uses this knowledge to refine incident categories and thresholds, which in turn affects the prompt content and model behavior.

Server reduces communication load between modules by using compact prompt sentences as integration points, rather than transferring full raw log datasets between processing components. When the generative AI model runs on a distinct computing device, server sends only prompt sentences rather than entire operational histories, reducing network traffic. Server introduces non-conventional sequencing of processing steps. Instead of first performing complete rule-based diagnosis and then using the model only for surface-level text generation, server uses the generative AI model as an analytical component that receives structured statistical and event information. Server thereby extracts cause candidate information and influence range information that would be difficult to encode in fixed rules alone. This architecture leverages strengths of both deterministic feature computation and probabilistic generative modeling.

### 8. Interaction with Terminal and User

Terminal displays incident lists, explanation information, and user response information in a structured layout. Terminal receives commands from user, such as selection of an incident or input of a custom prompt sentence for analysis.

User may input, through terminal, a prompt sentence such as:

“Analyze all high-severity login-related incidents in the last 12 hours and propose preventive actions.”

Terminal transmits this prompt sentence to server. Server retrieves corresponding operation information and explanation information for the requested period and incident type. Server composes a dialogue prompt sentence that includes the user-provided text and structured incident summaries. Server sends the dialogue prompt sentence to the generative AI model and returns the resulting dialogue response information to terminal. This interaction enables user to obtain detailed analyses without manually collating logs or metrics, thereby improving practical usability.

Terminal may additionally display controls for providing evaluation information. For example, terminal presents options such as “This explanation was helpful” or “This response was not accurate.” User selects an option, and terminal sends evaluation information to server. Server incorporates evaluation information into the prompt management module and updates templates or configuration values accordingly.

### 9. Alternative Embodiments and Variations

Server may use different types of generative AI models. In one alternative embodiment, server uses a smaller recurrent neural network-based model for on-premise deployment when GPU resources are limited. In another embodiment, server uses an external model service provided by a remote computational resource. In such a case, server still controls the content of prompt sentences and receives model outputs through an application programming interface.

Server may vary the internal representation of prompt sentences. In one embodiment, server formats prompt sentences using a tag-based structure, such as including markers like “[CONTEXT]” and “[TASK]” to delimit sections. In another embodiment, server includes key-value pairs in a pseudo-structured textual form like “error_code=AUTH-403; count=300; baseline=5;”. Such formatting can further improve robustness of the generative AI model's parsing of technical context.

Server may adjust feature computation. For some systems, server may compute multivariate anomaly scores using algorithms such as isolation forests or autoencoders. Server may then insert such anomaly scores into prompt sentences as additional fields, for example “anomaly_score: 0.95 (threshold: 0.8).” This allows the generative AI model to reason about a derived abnormality metric in addition to raw counts.

Server may also modify the training process to emphasize consistency and safety of model outputs. For example, server may use reinforcement learning from feedback, where evaluation information is used as a reward signal to push the model towards accurate and policy-compliant responses. This provides a further mechanism for technical improvement of automated explanation and response generation.

Through these embodiments, server, terminal, and user cooperate to implement a system in which structured prompt sentences, a transformer-based generative AI model, and feedback-driven refinement are combined to improve technical performance of incident detection, explanation, and response processing beyond mere automation of human tasks.

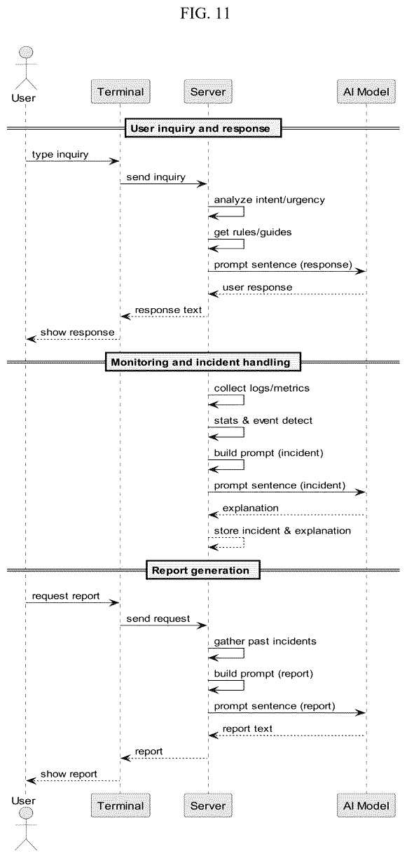

The following describes the processing flow using FIG. 11.

### Step 1:

Server acquires raw operation information from multiple components.

Server receives, as input, log lines from application processes, metrics from monitoring agents, and transaction records from backend services.

Server parses each log line using a text parsing algorithm (for example, regular expressions) to extract fields such as timestamp, component identifier, request path, status code, error code, and latency.

Server normalizes timestamps to a unified time zone and converts numeric values (for example, latency) to standardized units.

Server stores the extracted fields and normalized values as structured records in a database table or time-series store.

Server outputs structured operation information that is indexed by time and component.

### Step 2:

Server generates statistical information and event information from the structured operation information.

Server receives, as input, the structured operation information stored in the database.

Server executes aggregation queries to compute statistics such as error counts per minute, average response times per endpoint, maximum latency per service, and ratio of failed transactions.

Server calculates moving averages and standard deviations over sliding windows, and computes rate-of-change values by subtracting baseline metrics from current metrics.

Server compares these computed values with predefined thresholds and baseline profiles to determine whether any metric is abnormal.

Server creates event records for conditions that meet abnormality criteria, including fields for event type, time range, affected service, and summary description.

Server outputs statistical information and event information, which are stored in separate tables and made available to subsequent processing.

### Step 3:

Server detects an abnormal event and prepares context for generative analysis.

Server receives, as input, the event information and associated statistical information generated in Step 2.

Server evaluates whether any event record qualifies as an abnormal event based on severity rules (for example, error rate exceeding a baseline by a factor, or anomaly score above a threshold).

Server marks qualifying events as abnormal events and assigns severity levels such as low, medium, or high.

Server retrieves associated operation information and statistical summaries for the abnormal time window and affected components.

Server merges this information into a compact context structure that includes representative log samples, metric values, and identifiers of impacted services.

Server outputs an abnormal event record and its context, which are used as input for prompt sentence generation.

### Step 4:

Server generates a first prompt sentence for the generative AI model regarding the abnormal event.

Server receives, as input, the abnormal event record and its context from Step 3.

Server formats the context into human-readable segments, such as “Time window:”, “Service:”, “Error code:”, and “Error count: (baseline:).”

Server selects a template for abnormal event prompts and inserts the formatted segments into dedicated slots in the template.

Server appends explicit task instructions, such as “Summarize the abnormal event, propose likely causes, and classify severity.”

Server concatenates all segments and instructions into a single natural language sequence, forming the first prompt sentence.

Server outputs the first prompt sentence as a text string to be supplied to the generative AI model.

### Step 5:

Server invokes the generative AI model to generate explanation information based on the first prompt sentence.

Server receives, as input, the first prompt sentence from Step 4.

Server tokenizes the prompt sentence into a sequence of tokens according to the vocabulary of the generative AI model.

Server converts the tokens into numerical embeddings and feeds them into the transformer-based generative AI model running on a GPU.

Server performs forward propagation through the model's layers to compute probability distributions over output tokens at each decoding step.

Server applies a decoding algorithm (for example, beam search or nucleus sampling) to select output tokens and assembles them into natural language text.

Server obtains explanation information that includes a summary of the abnormal event, candidate causes, and a severity assessment.

Server stores the explanation information in association with the abnormal event record and outputs the explanation information for use by notification and reporting modules.

### Step 6:

Terminal receives user inquiry information and transmits it to server.

Terminal receives, as input, user-typed text in a chat interface or form field, such as “I cannot log in to my account. It keeps showing an error message.”

Terminal packages the inquiry text together with a user identifier and session identifier into a request payload.

Terminal sends the payload to server via a secure communication protocol.

Terminal displays a “processing” indicator to inform user that the inquiry is being analyzed.

Terminal outputs the payload to server as a network request.

### Step 7:

Server analyzes the inquiry information and extracts inquiry intention information and urgency information.

Server receives, as input, the inquiry payload from Terminal in Step 6.

Server stores the inquiry text and metadata in an inquiry table.

Server applies a language processing algorithm, such as a trained classifier model, to the inquiry text to assign an intent label (for example, “login issue”) and an urgency label (for example, “medium”).

Server may extract additional entities such as referenced error messages or device types using named entity recognition.

Server writes the extracted intention information, urgency information, and entities back into the inquiry record.

Server outputs a structured analysis result that includes inquiry intention information, urgency information, and entity information.

### Step 8:

Server retrieves rule information and guidance information and generates a response generation prompt sentence.

Server receives, as input, the analysis result from Step 7.

Server queries a knowledge information storage apparatus for documents, rules, and guidance entries related to the detected intent and urgency (for example, “login troubleshooting steps” and “security policies”).

Server selects top-matching rule information and guidance information based on keyword overlap or vector similarity.

Server composes a response generation prompt sentence by including: (i) the original user inquiry text, (ii) the detected intent and urgency, and (iii) selected rule and guidance snippets. Server adds explicit instructions such as “Generate a short, polite, and clear response following the company policy.”

Server concatenates these components into a single natural language prompt sentence.

Server outputs the response generation prompt sentence to be used as input to the generative AI model.

### Step 9:

Server invokes the generative AI model to generate user response information.

Server receives, as input, the response generation prompt sentence from Step 8.

Server tokenizes the prompt sentence, transforms tokens into embeddings, and inputs the embeddings to the generative AI model.

Server performs inference and decodes an output sequence of tokens into natural language text according to the instructions in the prompt sentence.

Server optionally applies post-processing, such as removing prohibited phrases or truncating overly long answers.

Server obtains user response information that explains steps the user should take, aligned with the retrieved rule information and guidance information.

Server stores the generated response in association with the original inquiry and outputs the response text to Terminal through an API response.

### Step 10:

Terminal presents the user response information to user.

Terminal receives, as input, the response text from Server in Step 9.

Terminal renders the response text in a chat bubble or message area within the user interface.

Terminal updates the conversation history to include both the user's inquiry and the system's response.

Terminal may provide interactive elements such as buttons or links included in the response, enabling user to trigger further actions (for example, opening a password reset page).

Terminal outputs the rendered response to user via the display unit.

### Step 11:

Server aggregates operation information and explanation information for past abnormal events and generates a report generation prompt sentence.

Server receives, as input, a report generation request specifying a time range or incident set.

Server queries the database for abnormal event records and associated explanation information within the requested scope.

Server computes aggregate metrics across events, such as total number of incidents, distribution of severities, and average resolution times.

Server formats a structured summary of each event and the aggregated metrics.

Server constructs a report generation prompt sentence including event summaries, metrics, and instructions such as “Generate a comprehensive post-incident report including root cause analysis and recurrence prevention measures.”

Server outputs the report generation prompt sentence for input to the generative AI model.

### Step 12:

Server invokes the generative AI model to generate report information.

Server receives, as input, the report generation prompt sentence from Step 11.

Server tokenizes and embeds the prompt sentence, and processes it through the generative AI model.

Server decodes an output text that includes sections for overview, root cause, impact, corrective actions, and recommended recurrence prevention measure information.

Server stores the report information as a document associated with the corresponding set of abnormal events.

Server outputs the report information to the dashboard backend module for later display and distribution.

### Step 13:

User reviews explanation information, user response information, and report information and provides evaluation information.

User views, on Terminal, an incident detail page, a chat conversation, or a report summary provided by Server.

User reads explanation information and user response information and determines whether the content is accurate and helpful.

User selects feedback options such as “Helpful” or “Not accurate” and may enter textual comments.

Terminal transmits this feedback as evaluation information to Server.

User thereby outputs evaluation information that indicates quality assessments of generated outputs.

### Step 14:

Server updates prompt sentence configurations based on evaluation information.

Server receives, as input, evaluation information from Terminal in Step 13.

Server correlates the evaluation information with the underlying first prompt sentences, response generation prompt sentences, and report generation prompt sentences used to produce the evaluated outputs.

Server analyzes patterns in evaluation scores, such as which templates or parameter settings correspond to low ratings.

Server modifies prompt templates, for example by adding clarifying instructions, adjusting requested level of detail, or tightening policy-related constraints.

Server may adjust decoding parameters of the generative AI model, such as temperature or maximum token length, for prompts associated with particular categories.

Server updates stored prompt configurations and parameter sets, and outputs revised prompt sentence templates that will be used for subsequent abnormal events, inquiries, and reports.

### Step 15:

Server generates analysis prompt sentences and dialogue prompt sentences for interactive analysis on request from user.

Server receives, as input, a user-generated prompt sentence entered on the dashboard, such as “Analyze all high-severity login-related incidents in the last 12 hours and propose preventive actions.”

Server retrieves corresponding operation information, abnormal event records, and explanation information that match the user's specified conditions.

Server constructs an analysis prompt sentence or dialogue prompt sentence that includes: (i) the user's original request, and (ii) structured summaries of the selected incidents and metrics.

Server sends the constructed prompt sentence to the generative AI model and receives dialogue response information that contains an analysis or recommendation tailored to the user's request.

Server returns the dialogue response information to Terminal for display.

Server outputs interactive analysis results that enable user to explore system behavior beyond pre-defined static reports.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional incident management systems and customer support systems in electronic transaction environments suffer from several technical deficiencies in how computing resources are utilized to detect abnormal events, analyze log information, and generate responses to end users and operators. Typical architectures merely collect sensor data and log information and apply simple rule-based thresholds or static pattern matching to detect abnormal events. Such approaches often fail to capture complex, evolving patterns in high-volume log streams, resulting in delayed or inaccurate detection of abnormal events. Furthermore, these systems usually handle user inquiries and operational analysis as separate processes, without a unified control flow that jointly leverages log information and user-facing content.

In many implementations, natural language inquiries from users are either handled manually or processed by rigid, pre-defined templates. As a result, the computing system cannot effectively use the rich context available in both the user inquiries and the underlying log information to generate precise, context-aware responses. This leads to redundant human intervention, increased response latency, and inconsistent quality in communication with users and stakeholders. The absence of an integrated, machine-controlled mechanism to generate prompts for advanced generative models further restricts the system from adapting to varied incident scenarios or dynamically adjusting responses based on real-time operational data.

Moreover, existing systems rarely employ learned inference models and generative models in a coordinated manner. Anomaly detection components may operate in isolation from natural language generation components, so that abnormality scores from learned inference models are not systematically fused into response generation or notification flows. This separation prevents the computing system from automatically constructing machine-readable and human-readable analysis result information that includes candidate causes and candidate countermeasures derived from log information. Consequently, operators must manually correlate different data sources and compose notifications or reports, which increases computational overhead on the operators and reduces the overall efficiency and reliability of system operation.

Accordingly, there is a need for an improved computing technique that allows a processor to: (i) monitor log information and determine occurrence of abnormal events using learned inference models; (ii) analyze user inquiries expressed in natural language and generate structured information such as intent and classification; (iii) automatically construct prompt sentences to instruct a generative information processing apparatus to generate response information; and (iv) integrate log-based analysis, anomaly scores, and generative outputs to automatically produce consistent, context-aware responses and notifications. By tightly coupling log analysis, anomaly detection, prompt generation, and generative response control within a single processing architecture, the computing system can reduce manual workload, shorten time-to-detection and time-to-response for abnormal events, and improve the technical performance of incident management and user support workflows.

The specific processing by the specific processing unit 290 of the data processing device 12 in Application Example 1 is realized by the following means.

The present invention provides a server comprising a processor configured to monitor log information including operation information acquired from at least one information source, determine whether an abnormal event has occurred based on the log information, analyze natural language information including inquiry content of a user acquired from an information processing terminal, identify intent information and classification information of the inquiry content, generate a prompt sentence for instructing a generative information processing apparatus to generate response information based on at least one of the inquiry content, the intent information, and the classification information, control the generative information processing apparatus such that the generative information processing apparatus generates the response information based on the prompt sentence and the log information, transmit the response information generated by the generative information processing apparatus to the information processing terminal, cause the information processing terminal to present the response information to the user, analyze the log information to identify candidate causes and candidate countermeasures of the abnormal event, generate analysis result information including the candidate causes and the candidate countermeasures, and automatically generate notification information to be transmitted to a related party and transmit the notification information based on at least one of the analysis result information and the log information when occurrence of the abnormal event is detected. This enables an integrated computer-controlled workflow in which anomaly detection based on learned inference models, natural language analysis of user inquiries, prompt generation for a generative information processing apparatus, and automatic creation of user-facing responses and operator notifications are coherently executed, thereby improving the accuracy, timeliness, and efficiency of incident detection, root-cause analysis, and communication in electronic transaction and similar computing environments.

The term “processor” refers to a hardware or virtual processing unit, such as a central processing unit or a programmable logic device, that executes instructions to perform operations on data and control functions of the system.

The term “information source” refers to any hardware or software component that produces operation information, including but not limited to sensors, application programs, operating systems, middleware, network devices, or storage subsystems.

The term “operation information” refers to information representing a behavior, status, or performance of a computing component or service, including but not limited to event records, error codes, response times, resource usage metrics, and transaction results.

The term “log information” refers to recorded data including at least operation information, which is stored in a storage apparatus or memory in chronological or structured form for later analysis and monitoring of system behavior.

The term “abnormal event” refers to a state or occurrence in which operation information indicates deviation from expected behavior of a system, service, or component, including faults, failures, performance degradation, or security incidents.

The term “information processing terminal” refers to an endpoint device that performs user interaction and communication with the server, including but not limited to a client computer, a portable terminal, or an embedded user interface device.

The term “user” refers to a human operator or end person who uses the information processing terminal to submit inquiry content, receive response information, and interact with the system.

The term “inquiry content” refers to natural language text or speech converted into text that is input by a user through an information processing terminal and that expresses a question, problem, request, or feedback regarding a service or system.

The term “natural language information” refers to information expressed in a human language, such as text or speech-converted text, which can be processed by natural language processing techniques to extract meaning, intent, or classification.

The term “intent information” refers to structured information representing a purpose, request type, or objective inferred from the inquiry content, such as a request for troubleshooting, a billing question, or a status confirmation.

The term “classification information” refers to information indicating a category or label assigned to the inquiry content, including but not limited to incident type, functional area, service type, or urgency level.

The term “generative information processing apparatus” refers to a computing component, including a generative AI model or generative algorithm executed by hardware, that receives a prompt sentence or structured input and generates output information such as response text or analysis text.

The term “prompt sentence” refers to a sequence of characters or tokens provided as an instruction or context to the generative information processing apparatus and used to control or condition generation of response information or analysis information.

The term “response information” refers to information generated by the generative information processing apparatus based on a prompt sentence and optionally log information, which is intended to be presented to a user and which includes at least a natural language response to the inquiry content.

The term “analysis result information” refers to information generated by analyzing log information and optionally by using the generative information processing apparatus, and including at least candidate causes and candidate countermeasures of an abnormal event.

The term “candidate causes” refers to one or more hypothesized reasons or root causes for an abnormal event, derived from analysis of log information or outputs of models, and not yet necessarily confirmed by manual validation.

The term “candidate countermeasures” refers to proposed remedial actions or configuration changes intended to mitigate, correct, or prevent recurrence of an abnormal event, derived from analysis result information.

The term “notification information” refers to information that is automatically generated for transmission to a related party, and that includes at least a description of the abnormal event, impact, and optionally the analysis result information.

The term “related party” refers to an operator, administrator, engineer, or other stakeholder who is responsible for monitoring, maintaining, or managing the system and who receives notification information for operational action.

The term “learned inference model” refers to a model, such as a statistical model or machine learning model, that has been trained using training data to infer an output value, such as an abnormality degree, from input feature values extracted from log information.

The term “feature values” refers to numerical or categorical values extracted from log information or operation information, which are used as inputs to the learned inference model for determining an abnormality degree or other metrics.

The term “abnormality degree” refers to a scalar or vector value indicating a magnitude or likelihood of abnormality estimated by the learned inference model based on feature values.

The term “analysis input information” refers to information including at least statistical information and summary information generated from log information, which is supplied, directly or indirectly, to the generative information processing apparatus for generation of a root cause and a countermeasure plan.

The term “statistical information” refers to quantitative data derived from log information by aggregation or computation, including but not limited to counts, averages, distributions, time-series metrics, and correlation indicators.

The term “summary information” refers to condensed descriptive data representing key aspects of log information or an abnormal event in natural language or structured form, used to provide context to the generative information processing apparatus.

The term “root cause” refers to an underlying factor or combination of factors that most directly explains the occurrence of an abnormal event as determined or hypothesized by analysis result information.

The term “countermeasure plan” refers to a structured proposal of one or more actions, procedures, or configuration changes designed to address the root cause and reduce the likelihood or impact of the abnormal event.

In the following embodiments, the term “server” denotes an information processing apparatus including at least one processor, a memory, a storage device, and a communication interface. The term “terminal” denotes an information processing terminal operated by a user, such as a client computer or a portable terminal, that communicates with the server. The term “generative AI model” denotes a generative information processing apparatus implemented by software executed on computing hardware.

The server executes programs stored in the memory to realize the functions defined in the claims. In one embodiment, the server uses a general-purpose processor, a volatile memory, a non-volatile storage device, and a network interface. The server executes an operating system and middleware including a web application framework (for example, a framework conforming to an HTTP server such as a lightweight web framework), a machine learning library (for example, a tensor computation library), and a natural language processing library (for example, a tokenization and embedding library). The server stores application logic and trained model parameters in the storage device and loads them into the memory at runtime. The terminal executes a client program such as a web browser or a native application. The terminal displays a graphical user interface that allows the user to input natural language inquiries as text. The terminal sends the inquiry content and associated metadata to the server through a communication network using a structured message format. The terminal receives response information from the server and renders the response information on a display for the user.

The user operates the terminal by inputting inquiry content relating to a malfunction or abnormal behavior of an electronic transaction service or other computing service. The user may input inquiries such as “My payment is not completing” or “I was charged twice for one order.” The terminal converts the user's keystrokes into text data and transmits the text data to the server.

The server receives inquiry content from the terminal via a network interface and an application program interface. The server stores the received inquiry content in a structured record that includes at least a user identifier, a time stamp, a communication channel identifier, and the textual content. The server stores the record in a relational or non-relational data structure, such as a table with fields for user attributes, inquiry attributes, and processing status.

The server performs natural language analysis of the inquiry content by executing a natural language processing module. The server uses a tokenizer component to convert a character sequence into a sequence of tokens, and uses an embedding component to convert each token into a high-dimensional numeric vector. The server applies an encoder network, for example a multi-layer neural network including recurrent units or attention-based units, to the token embeddings to compute a contextual representation of the inquiry content. The server applies a classification layer to this representation to obtain intent information and classification information, such as a label indicating “payment error,” “duplicate charge,” or “account lock,” and a confidence score for each label.

The server uses the identified intent information and classification information as structured data that is not directly visible to the user. The server stores these data in the memory and uses them as part of the control logic for subsequent processing. By converting free-form natural language into structured, machine-readable categories and intent vectors, the server improves the internal representation of user inquiries and enables subsequent modules to operate with reduced ambiguity and improved computational efficiency.

The server constructs a prompt sentence for the generative AI model by combining the inquiry content, the intent information, the classification information, and optionally additional context such as current incident status derived from log information. The server uses a template mechanism stored in the storage device. In one embodiment, the server uses a template such as:

“You are a customer support assistant for an electronic transaction service. Analyze the following user inquiry and generate a clear and polite response.

User inquiry: “My payment is not completing”

Answer:”

In another embodiment, the server uses a prompt sentence for root-cause analysis such as:

“You are an SRE assistant. Based on the following incident data, identify the most probable root cause and propose countermeasures.

### Incident Data:

Error code: PAYMENT_GATEWAY_TIMEOUT
Frequency increased 10× from 10:00 to 10:15 UTC
Only credit card payments affected
External gateway latency>5 seconds

### Output:

1. Probable root cause (2-3 sentences)
2. Recommended actions (bullet list)”

The server may further adjust the template dynamically by inserting classification information, severity level, or anomaly scores as additional textual context. The server thus generates a prompt sentence that contains both user-facing natural language content and machine-derived technical context. By doing so, the server constrains and guides the generative AI model to produce outputs that are coherent with the current operational state of the system.

The server executes the generative AI model on computing hardware, such as a graphical processing unit or a specialized accelerator, or accesses a remotely deployed model via an application program interface. In one embodiment, the generative AI model is an encoder-decoder neural network having an attention mechanism. The server represents the prompt sentence as a sequence of token identifiers and feeds the sequence to an embedding layer followed by multiple transformer blocks. Each transformer block includes a multi-head self-attention layer, a feedforward layer, normalization layers, and residual connections. The server computes output token probabilities at each time step using a softmax layer over a vocabulary.

The server generates response information token by token using an auto-regressive decoding algorithm such as beam search or sampling with temperature. The server uses specific decoding parameters, such as a beam width, a maximum output length, and a penalty for repetition, to balance diversity and determinism. The server may also apply constraints, such as forbidding certain tokens or enforcing particular keywords or phrases derived from the classification information. This controlled decoding process ensures that the generative AI model does not simply produce generic responses, but instead produces responses consistent with the system's technical status.

The server monitors log information including operation information from one or more information sources. The server deploys logging agents or logging libraries within application components and infrastructure components to record event information such as request identifiers, endpoint names, response codes, error codes, execution times, resource utilization, and dependency calls. The server stores log information in a log storage system such as a time-series database or a search engine, with indices over time, service, and error type. The server extracts feature values from log information by executing a feature extraction module. The server parses each log record and maps specific fields, such as response time and error code, into numeric and categorical features. The server applies normalization and encoding procedures, for example min-max scaling for latency and one-hot encoding for error types. The server groups feature values into time windows and service-specific streams. The server then forms input tensors that represent the temporal evolution of features across multiple time steps.

The server applies a learned inference model to the feature values to compute an abnormality degree. In one embodiment, the server uses an anomaly detection model such as an autoencoder. The server trains the autoencoder using historical log data that mostly reflect normal operation conditions. The server minimizes a reconstruction error function, such as a mean squared error between input features and reconstructed features, by updating network weights using an optimization algorithm such as stochastic gradient descent or a variant thereof. During operation, the server inputs current feature values into the trained autoencoder and computes a reconstruction error. The server interprets a large reconstruction error as a high abnormality degree, and compares the abnormality degree to a threshold. When the abnormality degree exceeds the threshold, the server determines that an abnormal event has occurred.

In another embodiment, the server uses a time-series prediction model such as a recurrent neural network or a transformer-based sequence model that predicts future feature values from past feature values. The server trains the model to minimize prediction error using a loss function such as mean absolute error. During operation, the server compares predicted feature values with observed feature values and uses the difference as an abnormality degree.

The server's use of learned inference models for anomaly detection improves the sensitivity and specificity of abnormal event detection compared to rule-based thresholds. The server dynamically adapts to changes in traffic patterns and error distributions represented in the log information. This reduces false positives and false negatives, thereby improving the technical performance of the monitoring subsystem and enabling earlier and more accurate detection of critical failures.

The server integrates results from anomaly detection with generative processing of inquiries. When the server determines that an abnormal event is occurring, the server adds incident-related context to the prompt sentence for the generative AI model. For example, the server may generate a prompt sentence such as:

“You are a customer support assistant for an electronic transaction service. The system is currently experiencing an incident where credit card payments may fail due to timeouts to an external payment gateway. Analyze the following user inquiry and generate a clear and polite response that reflects the current incident.

User inquiry: “My credit card payment keeps failing at checkout.”

Answer:”

By inserting machine-derived incident context into the prompt sentence, the server allows the generative AI model to produce responses that accurately reflect the real-time technical status of the system, without requiring manual intervention. This integration leads to reduced response time and more consistent communication across multiple user sessions. The server also generates analysis result information relating to abnormal events. The server aggregates log information for a period surrounding an abnormal event and computes statistical information such as error frequency per service, distribution of response times, and correlation between error codes and external dependencies. The server summarizes this information in natural language or structured form, forming analysis input information.

The server constructs a prompt sentence for the generative AI model that instructs generation of a root cause and a countermeasure plan based on the analysis input information. For example, the server may use a prompt sentence such as:

“You are an SRE assistant. Based on the following incident data, identify the most probable root cause and propose specific countermeasures.

### Incident Data:

Error code: PAYMENT_GATEWAY_TIMEOUT
Frequency increased 10× from 10:00 to 10:15 UTC
Only card payments via Provider A affected
External gateway latency>5 seconds
Internal application latency remains normal

### Output:

1. Root cause (2-3 sentences)
2. Countermeasures (bullet list)”

The server feeds this prompt sentence and the accompanying incident data into the generative AI model. The server obtains a root cause hypothesis and a countermeasure plan in natural language. The server stores the resulting analysis result information in a data structure associated with the incident. The server may further post-process the generated text, for example by validating format and extracting key phrases into structured fields, thereby combining unstructured and structured analysis outputs.

The server generates notification information for related parties based on analysis result information and log information. The server uses a notification template that includes fields for incident identifier, impact scope, root cause, and proposed countermeasures. The server inserts values taken from the analysis result information and from technical metrics into the template to generate notification content. The server transmits notification information to terminals used by operators, such as operator consoles, email clients, or messaging applications.

This architecture produces a technical improvement over naive automation of human tasks. The server does not merely replace an operator's manual drafting of messages with a generic text generator. Instead, the server designs a tightly coupled pipeline in which anomaly detection models, feature extraction modules, prompt construction logic, and generative AI models interact through well-defined data structures and control flows. The server improves the timeliness and coherence of responses by directly binding internal anomaly scores and statistical summaries to external communications. This reduces redundant data transport, reduces compute waste by avoiding irrelevant model invocations, and decreases network traffic by sending only necessary and contextually compressed information to the generative AI model.

The server reduces computational overhead and improves processing speed by using intermediate structured representations such as intent vectors and classification labels. These representations allow the server to filter, route, and condition prompt sentences without repeatedly re-analyzing raw text. The server can cache intent labels for recurring users and reuse them when similar inquiries are detected. This leads to reduced latency and improved throughput under heavy load.

In one embodiment, the server separates internal modules into microservices, including a log collection module, a feature extraction module, an anomaly detection module, a natural language analysis module, a prompt generation module, and a generative response management module. The server orchestrates these modules using asynchronous message queues. By decoupling modules, the server may scale the anomaly detection component independently from the generative response component, improving resource utilization and enabling horizontal scaling.

In another embodiment, the server uses different generative AI model architectures for different purposes. The server may use a relatively small, resource-efficient model for high-frequency, low-complexity user inquiries, and a larger model for complex incident analyses. The server determines which model to use based on classification information and anomaly degree. This selective invocation reduces computation cost and network latency and thus constitutes an improvement in the technical efficiency of the computing system. The terminal may implement additional local processing. For example, the terminal may perform local input validation and interface rendering without involving the server. The terminal may locally cache frequently used instructions or explanatory content, such that the server can return compact tags or identifiers instead of full text when appropriate. This reduces transmission size between the server and the terminal and further lowers communication load.

The user experiences improved reliability and speed, but the primary technical benefits occur inside the computing system. The server internally transforms high-volume, heterogeneous log information into well-structured feature vectors, automatically detects anomalies with trained neural networks, converts unstructured user language into machine-understandable intent, and orchestrates specialized generative AI models via carefully constructed prompt sentences linked to real-time system state. These coordinated operations yield measurable improvements in detection accuracy, response generation quality, and resource efficiency, and therefore represent an improvement to computer technology itself rather than merely automating a human workflow.

In still another embodiment, the server may employ alternative learning algorithms and network topologies. For instance, the server may implement a convolutional neural network over time-binned features to detect sharp spikes in error metrics; or a graph neural network to capture relationships between services in a distributed system. The server may use regularization techniques, early stopping, and data augmentation such as synthetic log perturbations to improve generalization and robustness of the learned inference models.

Model training may be performed offline on historical data and periodically updated with new data to adapt to evolving system behavior.

The above embodiments can be combined in various ways. The server may omit certain modules or replace them with alternative implementations depending on deployment constraints, while still performing the core functions of monitoring log information, determining abnormal events using trained models, analyzing inquiries in natural language, generating prompt sentences for generative AI models, and controlling generation and transmission of response information and notification information. Through these configurations, the system implements the claimed invention in a manner that can be realized on actual computing hardware and that produces concrete technical effects in terms of accuracy, performance, and efficiency of incident-related processing.

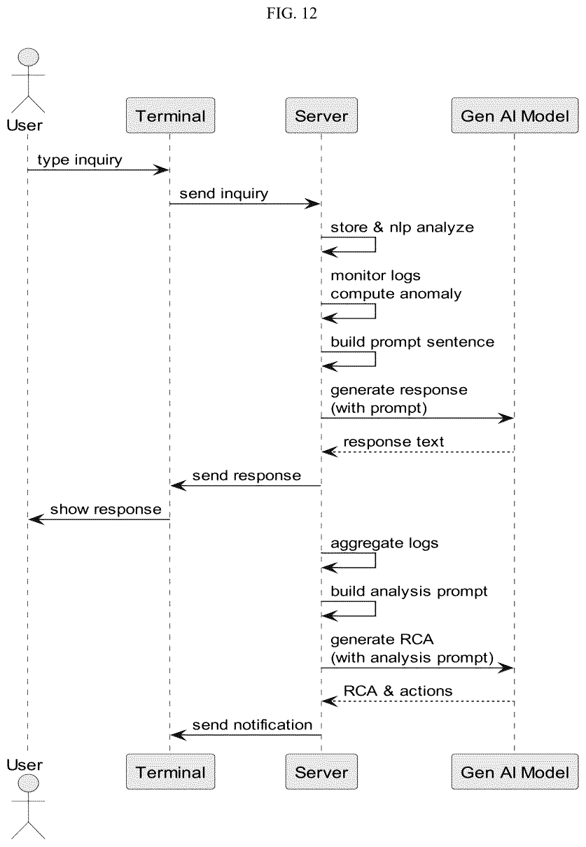

The following describes the processing flow using FIG. 12.

### Step 1:

The user inputs an inquiry on the terminal.

The user provides input text such as “My payment is not completing” into an input field of a graphical user interface rendered by the terminal. As input, the terminal receives raw keystrokes and converts them into a Unicode text string. As output, the terminal generates a structured inquiry object containing at least the text string, a user identifier, and a time stamp, stored in the terminal memory.

### Step 2:

The terminal transmits the inquiry object to the server.

The terminal uses a network communication module to serialize the inquiry object into a message format and sends the message to the server via a secure communication channel. As input, the terminal uses the structured inquiry object from Step 1. As output, the terminal produces a network packet stream that encapsulates the inquiry data and transmits it through a communication interface toward the server.

### Step 3:

The server receives and stores the inquiry data.

The server accepts the network packet stream through a network interface and reconstructs the original message into a structured inquiry record. As input, the server receives the serialized inquiry message from the terminal. The server parses the message fields, validates them, and writes the inquiry record into a storage structure such as a table with fields for user identifier, inquiry text, time stamp, and processing status. As output, the server produces a persistently stored record that can be referenced by subsequent processing modules.

### Step 4:

The server performs natural language preprocessing of the inquiry text.

The server reads the inquiry text field from the stored record and passes it to a natural language preprocessing module. As input, the server uses the raw Unicode text string of the inquiry. The server normalizes the text by applying lowercasing, whitespace normalization, and Unicode normalization, and then applies tokenization to split the text into lexical units. The server converts each token into a numeric identifier using a vocabulary mapping and forms a sequence of token identifiers. As output, the server produces a token sequence and associated metadata, stored in memory as arrays or tensors.

### Step 5:

The server infers intent and classification from the token sequence.

The server passes the token sequence to an intent classification model. As input, the server uses the sequence of token identifiers from Step 4. The server converts token identifiers into embedding vectors and feeds them into a neural network, such as a transformer encoder with multiple attention layers. The server computes hidden representations and then applies a classification layer that outputs probabilities over predefined categories such as “payment error,” “duplicate charge,” or “account status.” As output, the server generates intent information and classification information, including category labels and confidence scores, and attaches them to the inquiry record in memory.

### Step 6:

The server monitors log information and computes anomaly scores.

The server periodically reads log entries from a log storage system. As input, the server acquires multiple log records, each including fields such as time stamp, service identifier, response code, error code, and latency. The server extracts feature values by parsing these fields and converting them into numeric vectors, then feeds these vectors into a trained inference model such as an autoencoder or time-series predictor. The server computes an abnormality degree by calculating a reconstruction error or prediction error and comparing it to a threshold. As output, the server produces an abnormality flag and an anomaly score that indicate whether an abnormal event is currently occurring.

### Step 7:

The server determines incident context based on anomaly scores.

The server interprets the abnormality degree in the context of service-specific thresholds and operational policies. As input, the server uses the anomaly score and corresponding service identifiers from Step 6. The server executes comparison operations to determine whether the anomaly is localized, widespread, or transient, and assigns an incident status such as “normal,” “degraded,” or “incident.” As output, the server generates incident context data that includes the incident status, affected service identifiers, and a severity level, and stores this context for use in subsequent prompt generation.

### Step 8:

The server constructs a user-response prompt sentence for the generative AI model.

The server reads the inquiry text, intent information, classification information, and incident context. As input, the server uses these structured fields from Steps 3, 5, and 7. The server selects a template and performs string substitution to embed the inquiry text and any relevant incident description into the template. The server may generate a prompt sentence such as: “You are a customer support assistant for an electronic transaction service. The system is currently experiencing an incident where credit card payments may fail due to timeouts to an external payment gateway. Analyze the following user inquiry and generate a clear and polite response that reflects the current incident.

User inquiry: “My credit card payment keeps failing at checkout.”

Answer:”

As output, the server produces a complete prompt sentence stored as a character sequence ready for tokenization for the generative AI model.

### Step 9:

The server tokenizes and encodes the prompt sentence for generative processing.

The server takes the prompt sentence as text input and processes it with a tokenizer consistent with the generative AI model. As input, the server uses the character sequence from Step 8. The server divides the sentence into subword tokens and maps each token to an integer identifier, then constructs a tensor representing the sequence length and position of each token. As output, the server produces a model input tensor suitable for feeding into the generative AI model.

### Step 10:

The server generates response information using the generative AI model.

The server supplies the token tensor to the generative AI model implemented as an encoder-decoder or decoder-only neural network. As input, the server uses the encoded prompt tensor from Step 9. The server performs matrix multiplications, attention-weight calculations, and non-linear activations across multiple layers to compute probability distributions over the vocabulary for each output position. The server applies a decoding strategy such as beam search or sampling to select output tokens step by step until an end-of-sequence condition is met. As output, the server produces a sequence of output token identifiers representing the generated response.

### Step 11:

The server decodes and post-processes the generated response.

The server converts the output token identifiers back into text. As input, the server uses the output token sequence from Step 10. The server applies a decoder mapping from token identifiers to subword strings and concatenates them into a coherent text string, then removes special tokens and normalizes spacing. The server optionally applies content filters to remove prohibited phrases or enforce formatting rules. As output, the server obtains response information as a complete natural language text suitable for presentation to the user.

### Step 12:

The server records the inquiry-response pair and incident context.

The server updates the stored inquiry record with the generated response and the incident context used during generation. As input, the server uses the original inquiry record, the response text from Step 11, and incident status information from Step 7. The server writes a combined record to persistent storage that includes the inquiry, the model's response, model version identifiers, anomaly score, and classification labels. As output, the server produces a transaction log entry that can be used for later analysis, model retraining, or audit.

### Step 13:

The server transmits the response information to the terminal.

The server constructs a response message that encapsulates the generated response text and optionally incident indicators. As input, the server uses the response text from Step 11 and user-specific metadata from the inquiry record. The server serializes this data into a message format and sends it through the network interface to the terminal over a secure communication channel. As output, the server produces a network packet stream that delivers the response information to the terminal.

### Step 14:

The terminal receives and displays the response information.

The terminal accepts the network packet stream and reconstructs the response message. As input, the terminal uses the serialized response received from the server. The terminal parses the message, extracts the response text, and renders the text in a user interface component such as a chat bubble or message pane. As output, the terminal presents readable response information on the display so that the user can view the server's answer.

### Step 15:

The server aggregates log information related to an abnormal event.

The server queries the log storage using incident identifiers and time ranges derived from anomaly detection. As input, the server uses the incident context data from Step 7, including the time window and affected services. The server applies filtering operations to select only relevant log entries and computes aggregated metrics such as counts of error codes and average latencies. As output, the server produces statistical information and summary information that compactly describe the abnormal event.

### Step 16:

The server constructs an analysis prompt sentence for root-cause generation.

The server combines the statistical information and summary information into a textual incident description. As input, the server uses the aggregated metrics and key log patterns from Step 15. The server inserts this description into an analysis-oriented template, such as:

“You are an SRE assistant. Based on the following incident data, identify the most probable root cause and propose specific countermeasures.

### Incident Data:

Error code: PAYMENT_GATEWAY_TIMEOUT
Frequency increased 10× from 10:00 to 10:15 UTC
Only card payments via Provider A affected
External gateway latency>5 seconds
Internal application latency remains normal

### Output:

1. Root cause (2-3 sentences)
2. Countermeasures (bullet list)”

As output, the server generates an analysis prompt sentence suitable for instructing the generative AI model to produce an analysis result.

### Step 17:

The server generates analysis result information using the generative AI model.

The server processes the analysis prompt with the generative AI model in a similar manner to Steps 9 and 10. As input, the server uses the analysis prompt sentence from Step 16, tokenizes it, and feeds the resulting tensor into the model. The server performs neural network computations to generate a descriptive root cause and a list of countermeasures in natural language. As output, the server produces analysis result information containing at least a root cause description and a countermeasure plan.

### Step 18:

The server creates and sends notification information to related parties.

The server composes notification content by merging analysis result information with incident identifiers and impact information. As input, the server uses the root cause and countermeasure text from Step 17 and incident context from Step 7. The server formats this information into a notification message and transmits the message via configured channels such as operator dashboards, email, or messaging systems. As output, the server generates structured notification information that reaches terminals or systems used by related parties for operational action.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional incident management systems that monitor sensor data and log data typically rely on static rules, manually tuned thresholds, or fixed-format alert templates. Such systems suffer from several technical limitations in terms of computer technology.

First, when large-scale time-series data from multiple heterogeneous sources are monitored in real time, existing systems often perform independent and siloed processing for collection, detection, and notification. This leads to redundant data transformations, inefficient resource utilization in the processor and memory, and increased latency between anomaly occurrence and operator notification.

Second, anomaly detection models, even when employed, are frequently decoupled from the feedback produced by user interactions with notifications. As a result, thresholds and model parameters are not systematically updated based on the actual relevance and usefulness of generated alerts. This causes persistent false positives and false negatives, unnecessarily consuming computing resources for processing, transmitting, and storing low-value alerts, and degrading the effectiveness of automated detection over time.

Third, notification messages are generally generated from static templates, independent of the contextual structure of detected anomalies and independent of the characteristics of the target users or distribution channels. Consequently, the processor must either generate multiple hard-coded message variants or send overly generic notifications that lack sufficient technical detail. In both cases, the system does not efficiently leverage machine resources to adapt notification content to different channels and user roles, thereby reducing the operational value of each alert.

Fourth, existing systems do not tightly integrate a generative AI model with structured anomaly information and user feedback in a closed loop. The prompt sentences sent to the generative AI model are usually manually defined or are not dynamically adjusted according to anomaly type, severity, or historical user interactions. This results in suboptimal utilization of computational resources of the generative AI model, as well as a lack of systematic improvement in prompt quality and anomaly detection criteria.

In view of the foregoing, there is a need for an improved computer-implemented system that (i) unifies data aggregation, machine-learning-based anomaly detection, prompt sentence generation, and notification delivery on a processor; (ii) dynamically tailors prompt sentences and resulting notification messages to anomaly context and notification channels; and (iii) automatically updates detection thresholds and prompt generation rules based on structured user response information. Such a system should improve the technical functioning of the computer itself by reducing unnecessary processing, optimizing model execution and notification traffic, and enhancing the relevance and efficiency of alerts generated by the system.

The specific processing by the specific processing unit 290 of the data processing device 12 in Example 2 is realized by the following means.

The present invention provides a server comprising a processor configured to acquire and aggregate time-series sensor data and log data, to convert the aggregated data into a format processable by a machine learning process while performing data formatting, normalization, and feature extraction, to construct and store a trained discrimination model for identifying normal patterns and abnormal patterns based on past event data, to calculate an abnormality degree for newly input data by using the trained discrimination model and automatically detect an abnormal event by comparing the abnormality degree with a threshold, to generate, when the abnormal event is detected, a prompt sentence for instructing a generative AI model to generate notification content, the prompt sentence being automatically generated on the basis of structured information including an occurrence time of the abnormal event, an impact range, related indices, and summary information, to input the prompt sentence and the structured information into the generative AI model and cause the generative AI model to generate a notification message in natural language, to convert the generated notification message into a message format corresponding to a notification channel and perform delivery control to transmit the notification message to a user terminal, to acquire response operation information from the user terminal, to associate the response operation information with the abnormal event and the notification message, and to store the response operation information as learning data usable for improvement of the trained discrimination model or a generation logic of the prompt sentence. This enables an integrated computer-implemented pipeline in which data collection, anomaly detection, generative AI-based notification creation, and feedback-driven model and prompt optimization are executed cooperatively on the processor, thereby improving the technical performance of the system by reducing detection latency, lowering redundant processing and network traffic, and enhancing the precision and usefulness of automatically generated incident notifications.

The term “time-series sensor data” refers to measurement values output from one or more sensing devices at successive points in time, each value being associated with a timestamp and representing a physical, logical, or environmental state of a monitored resource.

The term “log data” refers to records generated by information processing components, each record including at least a timestamp and message content indicative of events, operations, status changes, or errors occurring in a computing environment.

The term “aggregate” refers to the operation of collecting data from a plurality of sources and combining the collected data into a unified dataset or stream indexed in time or by another key.

The term “machine learning process” refers to a computational procedure in which a model is trained or executed on digital data to infer patterns, make predictions, or produce classifications without being explicitly programmed for each possible input-output mapping.

The term “data formatting” refers to the transformation of input data into a structured representation, including at least parsing, type conversion, and organization into a predetermined schema suitable for further processing.

The term “normalization” refers to the operation of scaling, standardizing, or otherwise adjusting the range or distribution of data values so that they satisfy predetermined statistical or numerical conditions for machine learning.

The term “feature extraction” refers to the process of deriving one or more numerical or categorical attributes from raw data, the attributes being suitable as inputs to a machine learning model.

The term “trained discrimination model” refers to a machine learning model whose parameters have been adjusted through a training process using labeled or unlabeled event data so that the model produces outputs indicative of whether input data corresponds to a normal pattern or an abnormal pattern.

The term “abnormality degree” refers to a numerical or categorical value output by the trained discrimination model that quantifies the likelihood, intensity, or deviation of an input data instance being abnormal.

The term “threshold” refers to a reference value or criterion used to compare against the abnormality degree in order to determine whether an abnormal event is present.

The term “abnormal event” refers to a condition, state, or pattern in the monitored data that deviates from a normal pattern by exceeding the threshold according to the abnormality degree.

The term “structured information” refers to data representing one or more attributes of an abnormal event, the data being organized according to a defined schema, and including at least an occurrence time, an impact range, and one or more related indices.

The term “impact range” refers to information indicating at least one of an affected component, an affected service, an affected user group, or a geographical or logical domain influenced by an abnormal event.

The term “related indices” refers to numerical or symbolic indicators associated with an abnormal event, including at least performance metrics, error codes, counters, or statistical summaries.

The term “summary information” refers to a condensed representation of key aspects of an abnormal event, generated from raw data or structured information, and suitable for human or machine interpretation.

The term “prompt sentence” refers to a text string or set of text strings that instructs a generative AI model to perform a specified generation task, including at least generation of a notification message related to an abnormal event.

The term “generative AI model” refers to an artificial intelligence model configured to generate text or other data in response to input data, including at least large language models and other sequence generation models.

The term “notification content” refers to information to be delivered to a user or system, the information describing at least the occurrence, characteristics, and recommended responses for an abnormal event.

The term “notification message” refers to a message generated in natural language by the generative AI model based on a prompt sentence and structured information, and formatted for presentation to a user.

The term “notification channel” refers to a communication path or medium through which a notification message is transmitted, including at least electronic mail, push notification, and message-based communication.

The term “delivery control” refers to operations executed by the processor to select a notification channel, format a notification message accordingly, and manage transmission, retry, and logging of the notification.

The term “user terminal” refers to an information processing apparatus operated by a user, including at least a mobile device, a computing device, or a display-equipped appliance configured to receive and present a notification message.

The term “response operation information” refers to data indicating one or more operations performed by a user at the user terminal in reaction to a notification message, including at least confirmation, additional inquiry, and completion-of-response operations.

The term “learning data” refers to data stored for use in training, retraining, or updating a machine learning model or a rule set, the data including at least response operation information associated with abnormal events and notification messages.

The term “generation logic of the prompt sentence” refers to rules, parameters, or algorithms executed by the processor to construct or modify a prompt sentence based on structured information, user attributes, or historical response information.

The term “notification target” refers to an entity designated to receive a notification message, including at least a user, a user group, or a system endpoint associated with the user terminal.

The term “attribute of a notification target” refers to stored information describing characteristics of the notification target, including at least a role, a responsibility level, a preferred language, or a preferred notification channel.

The term “level of detail” refers to the granularity or amount of information included in a notification message, including at least the number of technical parameters, explanatory text segments, and recommended actions.

The term “generation rules for the prompt sentence” refers to configurable conditions and patterns defining how structured information and other context are mapped into textual elements of the prompt sentence.

In one embodiment, a server implements the claimed system by executing a program stored in a non-transitory computer-readable medium. The server includes at least one processor, a main memory, a network interface, and a storage device. The server operates under a general-purpose operating system, such as a UNIX-like operating system, and uses application software components implemented, for example, in a high-level programming language.

The server executes a data collection module that receives time-series sensor data and log data from multiple information processing devices over a communication network. The server uses a message streaming platform, such as a distributed log service, to aggregate records from a plurality of producer processes running on application servers, database servers, and network devices. The server stores the aggregated records in partitioned topics, each record including at least a timestamp field, a source identifier field, and a message payload encoded in a structured format.

The server executes a data preprocessing module implemented with a numerical computation framework, such as a matrix processing library and a data frame library. The server parses each log message into key-value pairs, converts textual timestamps into normalized time representations, and maps categorical values, such as component names and severity levels, into integer indices. The server normalizes continuous features, such as response time and resource usage, using standardization or min-max scaling techniques. The server organizes the preprocessed data in a structured data store as dense matrices, where rows correspond to time windows or events, and columns correspond to extracted features.

The server executes a model training module that constructs a trained discrimination model for identifying normal patterns and abnormal patterns. In one embodiment, the server implements the discrimination model as an autoencoder neural network using a deep learning framework. The server defines an input layer whose dimension matches the number of features, one or more hidden layers with decreasing dimensions forming an encoder, a latent layer representing a compressed embedding, and one or more hidden layers forming a decoder that reconstructs the input. The server applies a non-linear activation function, such as a rectified linear unit, in the hidden layers. The server initializes the network weights with a random distribution and defines a loss function as the mean squared error between the input vector and the reconstructed output vector.

The server trains the autoencoder using historical normal data and optionally labeled abnormal data. The server feeds mini-batches of feature vectors into the network, computes the forward pass to obtain reconstructed vectors, and computes the loss values. The server computes gradients of the loss with respect to the model parameters using backpropagation and updates the weights with a stochastic optimization algorithm, such as a variant of gradient descent. The server repeats this process over multiple epochs until the loss converges below a predetermined threshold or until a maximum number of epochs is reached. The server stores the trained model parameters and normalization parameters in the storage device as model artifacts associated with a model version identifier.

The server executes an anomaly scoring module that uses the trained discrimination model to compute an abnormality degree for new input data. The server applies the same preprocessing pipeline to incoming data, obtains feature vectors, and feeds the vectors into the encoder-decoder network. The server computes the reconstruction error as a norm, such as the L2 norm, between the input vector and the reconstructed vector. The server uses this reconstruction error as the abnormality degree or maps it to a score by applying a scaling or transformation function. The server compares the abnormality degree to a stored threshold, which the server derives initially from the empirical distribution of reconstruction errors on training data. When the abnormality degree exceeds the threshold, the server classifies the corresponding event or time window as an abnormal event and creates a structured anomaly record including at least the occurrence time, affected components, error metrics, and summarized statistics.

The server executes a prompt generation module that constructs a prompt sentence for a generative AI model. The server reads the structured anomaly record from the data store, extracts fields such as the time interval of the anomaly, the list of affected services, the types of errors, the numerical values of error rates and latencies, and a severity level inferred from rules or learned mappings. The server applies a rule-based template mechanism to combine this information into a coherent natural language instruction. The server uses conditional logic to insert different explanatory phrases and levels of detail depending on, for example, the severity level, the type of abnormality, and the intended notification channel.

For example, when the server detects a high-severity abnormal event in a transaction service, the server generates a prompt sentence such as:

“The server has detected an abnormal pattern in the transaction service logs. Analyze the following anomaly summary and generate a concise incident notification for on-call engineers. The notification must include an incident title, the time range, the affected components, the impact on users, and immediate troubleshooting steps. Anomaly summary: error rate increased from 0.3% to 30% between 10:02 and 10:07 UTC in the transaction service, with frequent timeout errors and database connection failures.”

In another example, when the server prepares a notification for a management audience, the server generates a different prompt sentence such as:

“The server has identified a critical system incident. Based on the following technical description, generate a brief notification suitable for management stakeholders, focusing on business impact and current status rather than low-level technical details. Anomaly summary: core payment functionality experienced a significant failure between 10:02 and 10:07 UTC, potentially affecting a large portion of user transactions, with elevated error responses and delayed processing.”

The server transmits the generated prompt sentence and the associated structured anomaly information to a generative AI model hosted either on the same server or on a remote inference server. The server packages the prompt sentence and structured fields in a request that is passed through a network interface using a protocol such as HTTP. The generative AI model implements a neural sequence generation architecture, such as a transformer-based language model, with multiple attention layers and positional encodings. The model parameters are stored in memory and are loaded at inference time. The server passes the prompt sentence as tokenized input to the language model, which computes context-sensitive token probabilities layer by layer and outputs a sequence of tokens forming a natural language notification message.

The server receives the notification message and performs post-processing, including token detokenization, removal of extraneous whitespace, and enforcement of maximum length. The server maps the generated content to a structured notification object comprising fields such as title, body, severity, and recommended actions. The server records the notification object in a notification store along with metadata such as the originating anomaly identifier and the target user group.

The server executes a delivery control module that formats the notification object for different notification channels. For a push notification channel, the server constructs a compact message including a brief title and a short body, and associates the message with device tokens corresponding to user terminals. For an email channel, the server constructs a full message including the entire generated body and a subject line derived from the incident title. For a chat channel, the server constructs a structured text block containing headings and bullet lists. The server invokes appropriate network services for each channel, such as a push notification service, a mail transfer agent, or a messaging API, using the network interface. The server also applies rate limiting and prioritization logic when multiple incidents occur, thereby reducing network congestion and ensuring timely delivery for higher-severity notifications.

The terminal receives the notification via its platform-specific interface. The terminal may be a mobile device, a general-purpose computer, or a specialized console equipped with a display and input devices. The terminal executes a client application or user interface program that registers for notifications and maintains a persistent or periodic communication connection with the server or an intermediary notification service. The terminal parses received notification payloads and displays the notification message in a user interface component, such as a pop-up banner or a detail screen. The terminal presents at least part of the generated notification body and provides user interface controls for acknowledgement, additional inquiry, or marking the incident as resolved.

The user operates the terminal to review and respond to notifications. The user may select a control to indicate that the notification has been acknowledged, to request additional technical details, or to confirm that remediation is complete. The terminal sends these response signals back to the server as response operation information, including identifiers of the corresponding incident and notification and the type of user action taken. The server records each response in association with the abnormal event and the notification content. The server aggregates response operation information to form a dataset that reflects which notifications were considered useful, timely, or excessive.

The server executes a feedback processing module that uses the response operation information to adjust the trained discrimination model and prompt generation logic. In one embodiment, the server computes statistics correlating abnormality degree values with user confirmations. If a significant number of notifications for low abnormality degrees are consistently unacknowledged or marked as not useful, the server adjusts the anomaly detection threshold upwards by modifying the stored threshold value. Conversely, if users frequently mark incidents as severe that correspond to moderate abnormality degrees, the server lowers the threshold. The server may also retrain the discrimination model by including additional training samples derived from events for which user responses indicate misclassification, thereby updating model weights and reducing future false positives or false negatives.

The server updates the prompt generation logic based on response operation information. If users often request additional technical information for a particular category of incident, the server modifies rules that control the level of detail in prompt sentences, for example by inserting explicit metric values or configuration hints. If management users rarely interact with highly technical notifications, the server modifies prompt templates for that user group to emphasize impact and status over internal metrics. These modifications cause the server to construct different prompt sentences for the same underlying anomaly, depending on the target user attributes and historical feedback, improving the suitability and efficiency of the generative AI model's output.

By organizing the data flow into structured data structures, such as feature matrices, anomaly records, notification objects, and feedback records, the server reduces redundant parsing and transformation operations. The server applies consistent preprocessing before both training and inference, which stabilizes the distribution of inputs to the discrimination model and leads to more accurate anomaly scores. The closed-loop integration of anomaly detection, generative AI-based notification generation, and feedback-driven threshold and prompt optimization reduces the volume of unnecessary notifications transmitted across the network and improves the precision of alerts. As a result, the server achieves lower latency from anomaly occurrence to meaningful notification, reduces processor cycles spent on processing uninformative events, and optimizes bandwidth usage for notification delivery. The server thereby improves computer technology itself in several respects. The server restructures anomaly detection from static rule evaluation into a dynamic model-based scoring process that learns from historical and ongoing feedback, which reduces computational waste and increases detection accuracy. The server uses a generative AI model in a constrained, structured manner by providing carefully constructed prompt sentences and anomaly schemas, which leads to more predictable generation behavior and avoids the need for numerous hand-crafted templates stored and evaluated by the server. The server encodes user responses into structured learning data used to automatically tune thresholds and prompt rules, eliminating manual rule editing and enabling the system to adapt without human reconfiguration of internal parameters. These mechanisms produce concrete technical effects, including improved processing speed for real-time anomaly evaluation, improved accuracy of anomaly detection, reduced memory and storage consumption for redundant logs and alerts, and reduced communication overhead for distributing notifications.

In alternative embodiments, the server may implement the discrimination model as a different machine learning structure, such as a recurrent neural network, a convolutional network applied to time-series segments, or a tree-based anomaly detection algorithm. The server may apply different loss functions, such as a robust loss function less sensitive to outliers, or may use semi-supervised training procedures that combine labeled abnormal samples with abundant unlabeled normal data. The server may additionally apply data augmentation techniques, such as synthetic noise injection into normal samples or temporal shifting, to improve model robustness. The server may also adjust the architecture of the generative AI model, such as changing the number of layers or the embedding dimension, to adapt to the complexity of prompts and required output quality, while retaining the same overall data flow and feedback integration.

In further embodiments, the terminal may provide additional visualization functions, such as graphs of error rates and latency over time, derived from structured anomaly records transmitted by the server. The user may interact with these visualizations to annotate incidents or specify preferred notification granularity. The server incorporates these annotations as part of the response operation information and uses them to refine not only thresholds and prompt generation rules but also the feature selection process in the preprocessing module, further improving computational efficiency and detection performance.

Thus, by specifying concrete data structures, neural network architectures, preprocessing algorithms, feedback mechanisms, and channel-specific notification formatting, the system implements more than an abstract idea of monitoring and notification. The system provides a technically specific, computer-centered improvement that restructures how sensor and log data are processed, how anomalies are scored, how generative AI models are invoked via prompt sentences, and how user feedback is systematically integrated to optimize future computation.

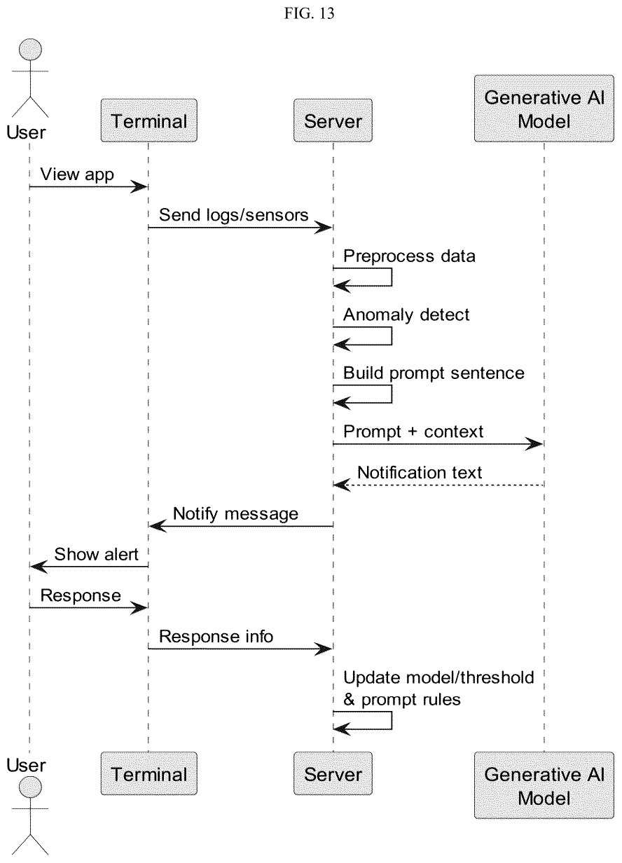

The following describes the processing flow using FIG. 13.

### Step 1:

The server collects raw time-series sensor data and log data.

The server receives, as input, individual records transmitted from multiple source systems, each record including at least a timestamp, a source identifier, and a message payload. The server uses a streaming middleware to aggregate these records into one or more ordered data streams. The server appends each received record to a corresponding topic or queue, and the server stores the records in a storage device with indices on time and source. As a result, the server outputs an aggregated raw data stream in which records from heterogeneous sources are unified into a common structure and can be retrieved in time order.

### Step 2:

The server preprocesses the aggregated raw data to generate feature vectors.

The server obtains, as input, batches of raw records from the aggregated data stream produced in Step 1. The server parses each message payload to extract fields such as event type, severity, response time, and error code. The server converts textual timestamps into numerical time values, encodes categorical fields into integer or one-hot representations, and normalizes numerical fields using predetermined scaling parameters. The server performs data cleaning by removing duplicate records and filling missing values according to predefined rules. By applying these data transformations, the server outputs a structured feature matrix in which each row corresponds to an event or time window and each column corresponds to a numerical or categorical feature suitable for machine learning.

### Step 3:

The server trains a discrimination model for anomaly detection.

The server uses, as input, the feature matrix generated in Step 2 and labels or indicators identifying normal and abnormal samples when available. The server initializes parameters of a neural network, such as an autoencoder, including the number of layers, number of units per layer, and activation functions. The server repeatedly performs forward computation by propagating input feature vectors through the network to obtain output vectors, computes an error value based on a loss function such as mean squared error between input and output, and then performs backpropagation to update network weights using an optimization algorithm. The server iterates this learning process over multiple epochs until convergence criteria are satisfied. The server outputs a trained discrimination model, including learned weights and associated preprocessing parameters, which is stored in a model repository for later inference.

### Step 4:

The server computes an abnormality degree for newly received data.

The server acquires, as input, new raw records from the aggregated data stream and applies the same preprocessing operations as in Step 2 to generate feature vectors for the new data. The server loads the trained discrimination model produced in Step 3 and performs forward computation on each new feature vector to obtain a reconstructed vector or an internal representation. The server calculates a reconstruction error or anomaly score by computing, for example, the L2 distance between the input vector and the reconstructed vector or another statistical metric. The server compares the computed anomaly score with a stored threshold value. The server outputs an abnormality degree and a binary or multi-level classification indicating whether each new data point is normal or abnormal.

### Step 5:

The server generates a structured anomaly record when an abnormal event is detected.

The server receives, as input, anomaly scores and classification results from Step 4. For each data point or time window classified as abnormal, the server aggregates associated contextual information, including the time range, affected components, error counts, latency statistics, and previous related events. The server organizes this information into a structured anomaly record following a predefined schema. The server may compute additional derived metrics, such as the rate of change of error counts, clustering of similar events, or estimated impact level, using arithmetic operations and statistical functions. The server outputs a structured anomaly record that encapsulates all relevant data required for notification generation.

### Step 6:

The server constructs a prompt sentence for a generative AI model based on the structured anomaly record.

The server uses, as input, the structured anomaly record created in Step 5 and configuration data describing target user roles and notification channels. The server selects a prompt template and inserts specific values such as anomaly time range, affected services, error types, abnormality degree, and estimated impact. The server applies conditional rules to adjust wording and level of detail according to severity and target audience attributes. For example, the server may generate a prompt sentence such as:

“The server has detected an abnormal pattern in the system logs. Analyze the following anomaly summary and generate a concise incident notification for on-call engineers. The notification must include an incident title, the time range, the affected components, the impact on users, and immediate troubleshooting steps. Anomaly summary: error rate increased from 0.3% to 30% between 10:02 and 10:07 UTC in the transaction service, with frequent timeout errors and database connection failures.”

By combining template text and structured values, the server outputs a complete prompt sentence and an associated context bundle ready to be sent to the generative AI model.

### Step 7:

The server invokes the generative AI model to generate a notification message.

The server takes, as input, the prompt sentence and context bundle produced in Step 6. The server encodes the prompt sentence into tokens using a tokenizer compatible with a transformer-based language model and transmits the tokens and context to the generative AI model, which may be running locally or on a remote inference node. The generative AI model performs matrix multiplications and attention operations across multiple layers to compute probability distributions over output tokens conditioned on the input prompt. The server iteratively samples or selects tokens based on these probabilities until an end-of-sequence condition is met. The server decodes the sequence of tokens back into text, thereby obtaining a natural language notification message that describes the abnormal event, its impact, and recommended actions. The server outputs the generated notification message as a text string.

### Step 8:

The server formats and distributes the notification message to one or more terminals.

The server uses, as input, the notification message generated in Step 7, along with metadata such as severity level, incident identifier, and target user group. The server selects one or more notification channels based on user preferences and system configuration. For each selected channel, the server transforms the notification text into a channel-specific format, for example truncating and summarizing for a push notification or adding headings and sections for an email. The server attaches addressing information such as device tokens, email addresses, or chat endpoints, and uses network protocols to transmit the formatted messages through the appropriate communication services. The server records transmission status and any delivery identifiers. The server outputs channel-specific notification payloads that are delivered to terminals operated by users.

### Step 9:

The terminal receives and displays the notification message.

The terminal obtains, as input, a notification payload sent by the server via a push service, email protocol, or messaging interface. The terminal parses the payload to extract the title, body, and incident metadata. The terminal invokes its local notification subsystem to present a visible or audible alert to the user, such as a banner or pop-up window. The terminal renders the notification body text on a display and may provide interface controls for actions like “Acknowledge,” “View details,” or “Mark as resolved.” Based on the parsed content and user interface layout rules, the terminal outputs a visual presentation that allows the user to perceive and interact with the generated notification.

### Step 10:

The user reviews the notification and performs a response operation.

The user receives, as input, the visual notification displayed on the terminal and the associated controls. The user reads the content, interprets the described abnormal event and recommended actions, and selects one or more response options, such as acknowledging the alert, requesting more information, or confirming that remediation steps are complete. The user may also navigate to a detailed view to inspect additional technical data. As a result of these interactions, the user outputs response signals via input devices on the terminal, which are encoded as response operation information including the type of action chosen and identifiers of the related incident and notification.

### Step 11:

The terminal transmits response operation information to the server.

The terminal uses, as input, the response operation information produced by the user interaction in Step 10. The terminal packages this information into a request message containing at least the incident identifier, the selected response type, and a timestamp. The terminal sends the request over the network to an endpoint exposed by the server. The terminal may apply retries and basic error handling to ensure reliable delivery. The terminal outputs a formatted response message that is received and processed by the server.

### Step 12:

The server records response operation information and updates model and prompt configurations.

The server receives, as input, the response operation information transmitted from the terminal in Step 11. The server stores each response in association with the corresponding abnormal event, notification message, and abnormality degree in a feedback data store. The server then performs statistical analysis on aggregated feedback, such as computing frequencies of acknowledgements for different ranges of abnormality degree or counting requests for additional information per incident type. Based on these computations, the server adjusts the threshold for anomaly detection by modifying stored threshold values or retraining the discrimination model on an expanded dataset that includes events labeled implicitly by user response. The server also updates rules and parameters used in the prompt generation module, for example increasing the level of detail in prompt sentences for classes of incidents that frequently trigger additional inquiries. The server outputs updated model parameters and prompt generation rules, which will be applied to subsequent iterations of Steps 4 through 7 to improve detection accuracy and the relevance of generated notification messages.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional incident management and user support systems in computing environments generally handle anomaly detection, user inquiry processing, and response generation as separate, weakly coupled functions. A typical system monitors sensor streams or log data with fixed rules, detects abnormal events with limited accuracy, and then creates human-authored notifications or knowledge-base articles that are manually selected and sent to users or operators. In parallel, a separate chatbot or FAQ system may use natural language processing to classify user inquiries and return static answers from a predefined repository. These approaches suffer from several technical shortcomings.

First, conventional systems do not integrate low-level machine monitoring and high-level natural language interaction into a unified computational pipeline. As a result, anomaly detection models may detect an incident, but the system does not automatically generate a technically consistent and context-aware natural language explanation of the incident for different audiences. This forces human operators to manually interpret structured logs, translate them into user-facing language, and craft incident summaries. Such manual translation introduces latency, inconsistency, and error, and prevents the real-time utilization of anomaly detection results at the user interface layer.

Second, existing natural language interfaces typically ignore user emotional state when generating responses. In many deployments, the response generator returns a generic answer based only on intent classification. The system does not computationally capture user emotion (e.g., anger, confusion, anxiety) from the user's utterance, nor does it condition the text-generation behavior on this emotion. As a consequence, the system often provides responses that are technically correct but inappropriate in tone or level of detail, leading to repeated inquiries, user dissatisfaction, and inefficient use of computing and network resources due to unnecessary back-and-forth interactions.

Third, current generative AI based response systems often treat the generative AI model as an isolated component that receives a loosely specified prompt and returns uncontrolled output. The prompt content is not systematically constructed from structured incident data, intent analysis, and emotion analysis; nor is there a feedback loop that uses actual user reactions to refine prompt design and analysis conditions. This results in unstable response quality, potential policy violations, and an inability to computationally improve the system over time based on observed interaction data.

Fourth, conventional architectures do not provide an end-to-end mechanism for automatically generating both user-oriented and operator-oriented responses from a common set of machine-level records and analysis results. User-facing responses require simplified, empathetic explanations suitable for non-experts, while operator-facing responses require concise technical summaries and initial response plans. Without a unified computing process that branches responses for multiple audiences based on shared analytical results, duplication of logic occurs, maintenance costs increase, and internal inconsistencies arise between what users are told and what operators see.

Accordingly, there is a need for an improved computer-implemented technique that: (i) acquires and stores observation information about abnormal events; (ii) jointly analyzes recorded machine data and user inquiry text using natural language processing and machine learning to identify both user intent and user emotion together with technical incident summaries; (iii) constructs structured prompt sentences that precisely control a generative AI model based on these analytical results; (iv) post-processes the model's output in a deterministic manner to adjust expression style and detail level for different audiences; and (v) uses interaction history and user reaction information to update analysis conditions and prompt patterns. By addressing these technical issues, the invention aims to improve the functioning of the computer system itself, including more efficient utilization of computational resources, reduced latency to generate appropriate responses, improved stability and predictability of generative AI outputs, and reduced need for manual intervention in incident explanation and user support workflows.

The specific processing by the specific processing unit 290 of the data processing device 12 in Application Example 2 is realized by the following means.

The present invention provides a server comprising a processor configured to acquire observation information related to abnormal events from sensors and log-producing components and to store such observation information as structured record information in a storage device, to perform analysis processing using natural language processing procedures and machine learning procedures on the record information and on inquiry information acquired from a user so as to identify an intention contained in the inquiry information and an emotional state of the user and to identify, based on the record information, presence or absence of an abnormal event together with a technical summary associated with the abnormal event, to construct a prompt sentence for input to a generative AI model based on the intention, the emotional state, and the technical summary and to instruct the generative AI model to execute response generation processing in accordance with the prompt sentence, to adjust an expression content and a level of detail of response information obtained from the generative AI model in accordance with the emotional state and a predetermined response policy so as to generate user-oriented response information and operator-oriented response information, to transmit the user-oriented response information and the operator-oriented response information as notification information to a communication terminal and to cause the communication terminal to perform display control based on the notification information, and to store a correspondence between the inquiry information and the response information and reaction information from the user with respect to the response information and to execute learning processing for updating at least one of the prompt sentence and processing conditions of the analysis processing on the basis of the stored correspondence and reaction information. This enables the computer system to automatically transform low-level observation data and user inquiries into context-aware, emotion-aware, and audience-specific natural language responses under controlled interaction with a generative AI model, thereby improving the technical performance of anomaly handling and user support workflows by reducing manual intervention, decreasing response latency, stabilizing output quality through structured prompt construction and feedback-based refinement, and more efficiently utilizing computing and communication resources.

The term “observation information” refers to information indicating behavior or state of a computing environment, including but not limited to sensor outputs, log entries, event records, and monitoring signals that are acquired for the purpose of detecting or analyzing abnormal events.

The term “record information” refers to observation information that has been stored in a storage device in a structured or semi-structured format, such as database records, time-series entries, or indexed files, optionally including associated metadata such as timestamps, identifiers, and categories.

The term “abnormal event” refers to a deviation from expected operation of a system, device, or service, including but not limited to security incidents, performance degradation, functional errors, and anomalous usage patterns, which is detectable from observation information.

The term “inquiry information” refers to information representing a request, question, complaint, or report transmitted by a user to the system, typically expressed as natural language text or speech that has been converted into text for processing.

The term “natural language processing” refers to computational techniques for analyzing, understanding, and manipulating human language data, including but not limited to tokenization, part-of-speech tagging, syntactic and semantic parsing, entity extraction, intent classification, and sentiment analysis.

The term “machine learning” refers to computational techniques by which a model is trained from data to perform tasks such as classification, regression, clustering, anomaly detection, or feature extraction without being explicitly programmed with task-specific rules.

The term “intention” refers to a representation of a user's goal, request type, or purpose inferred from inquiry information, such as requesting a refund, reporting a failure, asking for status information, or disputing a transaction.

The term “emotional state” refers to a characterization of a user's emotion inferred from inquiry information or related context, including but not limited to categories such as anger, frustration, confusion, anxiety, satisfaction, or neutrality, optionally quantified by an intensity level.

The term “technical summary” refers to a machine-readable and human-readable description of an abnormal event or system state derived from record information, including essential technical aspects such as cause hypotheses, affected components, time range, severity, and relevant metrics.

The term “generative AI model” refers to a computational model that generates new data, such as natural language text, based on input information, the model having been trained using machine learning to produce outputs that follow patterns learned from training data.

The term “prompt sentence” refers to an input text or structured instruction supplied to a generative AI model, the prompt sentence specifying at least a task, context, and constraints that guide the model's response generation behavior.

The term “response information” refers to information output by a generative AI model or by post-processing of such output, the response information including natural language text intended to answer an inquiry, describe an incident, or provide guidance.

The term “user-oriented response information” refers to response information that is formatted, filtered, and expressed for presentation to a non-expert user, typically using simplified terminology, appropriate tone, and a level of detail suitable for end users.

The term “operator-oriented response information” refers to response information that is formatted and expressed for presentation to an operator, administrator, or expert user, typically including technical details, incident summaries, and recommended operational actions.

The term “expression content” refers to lexical choices, phrasing, tone, and sentence style used in response information, including the presence or absence of specific expressions such as apologies, reassurances, and procedural instructions.

The term “level of detail” refers to a granularity of information contained in response information, including how many steps, parameters, technical terms, or explanatory elements are provided, and how deeply a topic is described.

The term “response policy” refers to one or more predefined rules, templates, or constraints that govern how response information should be generated or adjusted, including rules concerning allowed content, tone, length, and structure for different situations and user types.

The term “communication terminal” refers to any user-side or operator-side device capable of transmitting inquiry information to the server and receiving notification information from the server, including but not limited to mobile terminals, computers, and network-connected displays.

The term “notification information” refers to information transmitted from the server to a communication terminal to inform a user or operator of a response, an incident, a status update, or a recommended action, typically including at least one piece of response information.

The term “display control” refers to an operation performed by a communication terminal to present notification information to a user or operator, including rendering text, icons, or interactive elements on a display in accordance with presentation instructions embedded in the notification information.

The term “reaction information” refers to information indicating a user's or operator's behavior or feedback with respect to response information, including but not limited to follow-up inquiries, explicit evaluations, click behavior, dwell time, and completion or non-completion of suggested actions.

The term “learning processing” refers to processing that uses accumulated data, including correspondences between inquiries and responses and reaction information, to update parameters, rules, or models used in analysis processing, prompt sentence construction, or response adjustment.

The term “analysis processing” refers to a set of computational operations performed on record information and inquiry information, including but not limited to natural language processing, intent detection, emotion estimation, anomaly detection, and extraction of technical summaries.

The term “abnormality detection model” refers to a machine learning model that evaluates record information to compute an abnormality degree or classification, the model having been trained to distinguish abnormal patterns from normal patterns.

The term “abnormality degree” refers to a value or score indicating a likelihood, intensity, or severity of an abnormal event in record information as determined by an abnormality detection model.

The term “style condition” refers to a parameter or constraint included in a prompt sentence that specifies stylistic requirements for the response, such as politeness level, formality, emotional tone, or use of technical terminology.

The term “explanation granularity condition” refers to a parameter or constraint included in a prompt sentence that specifies a required level of detail for the explanation, such as brief overview, step-by-step procedure, or in-depth technical discussion.

The term “gratitude expression” refers to a phrase or wording in response information that expresses thanks to a user or operator, such as acknowledging their report or cooperation.

The term “apology expression” refers to a phrase or wording in response information that expresses regret or apology, typically used when an abnormal event or inconvenience has occurred.

The term “reassurance expression” refers to a phrase or wording in response information that is intended to reduce user anxiety or concern, such as clarifying protections, next steps, or support availability.

The term “procedural explanation expression” refers to a phrase or wording in response information that describes concrete steps or procedures to be performed by a user or operator to resolve or further investigate an issue.

In one embodiment, a server includes a processor, a main memory, a non-volatile storage device, and a network interface coupled via a system bus. The server executes a program stored in the storage device to implement the functions described below. The server communicates with one or more terminals via a communication network. Each terminal includes a processor, a memory, a display unit, an input unit, and a communication interface. A user operates the terminal to submit inquiry information and to view response information and notifications.

The server stores observation information, record information, inquiry information, response information, and reaction information in a storage device implemented by a relational database management system and/or a time-series data store. The server uses software components including an operating system, a database management system, and middleware for message queuing. The server further uses libraries for natural language processing and machine learning, such as a numerical computation framework, a neural-network framework, and a language processing library.

The server acquires observation information from sensors and log-producing components of an information system. A sensor may be a monitoring device such as a performance monitor, a security monitoring device, or a network monitoring device. Log-producing components may include application servers, authentication servers, storage systems, or communication devices that output log entries in text or structured formats. The server converts raw log entries and sensor outputs into record information by parsing each entry, extracting fields such as timestamps, identifiers, event types, and metrics, and storing the parsed data as structured records. The record information is stored in tables or time-series structures with indexes on identifiers and times, enabling efficient retrieval and correlation by the server. The server receives inquiry information from the terminals. The terminal transmits user-entered natural language text, such as “I cannot log in to my account and I am very worried,” together with metadata including user identifiers and device identifiers. The server stores the inquiry information in an inquiry table, including fields for the text content, submission time, and processing status. The server may store an association between the inquiry information and related record information, for example by linking an inquiry to recent abnormal events involving the same user identifier or device identifier.

The server analyzes the record information and the inquiry information using natural language processing and machine learning. For natural language processing, the server may use a language processing library to perform tokenization, part-of-speech tagging, syntactic parsing, and named-entity recognition. The server may also use an intent classification model that receives as input a sequence of token embeddings corresponding to the inquiry information and outputs an intention indicating a class such as “login problem,” “transaction dispute,” or “delivery delay.” The intent classification model may be implemented as a neural network including an embedding layer, a sequence processing layer, and a classification layer.

The server estimates an emotional state of the user based on the inquiry information. The server may use a sentiment analysis model that outputs a polarity score and an emotion category. For example, the server may implement a neural network receiving token sequences and outputting probability values for categories such as anger, frustration, confusion, and neutrality. The server stores the emotional state as an emotion label and an intensity value associated with the inquiry information.

The server evaluates record information with an abnormality detection model to identify abnormal events. The abnormality detection model may be an autoencoder or another neural network-based model. In one example, the server constructs feature vectors from record information by aggregating counts of specific event types, average response times, error code frequencies, or security-related indicators within fixed time windows. The server inputs the feature vectors to an autoencoder including multiple encoder layers and decoder layers. During training, the server minimizes a reconstruction error between input feature vectors and reconstructed outputs using a loss function such as mean squared error. The server updates model parameters using gradient descent or a variant thereof. In operation, the server computes an abnormality degree by measuring the reconstruction error for new feature vectors; an abnormality degree exceeding a threshold indicates an abnormal event. The server determines a technical summary by selecting and aggregating the most relevant features and related record information corresponding to the time window and identifiers exhibiting high abnormality degrees.

The server combines the intent, the emotional state, and the technical summary to construct a prompt sentence. The server uses a prompt construction component to generate a textual instruction for a generative AI model. The prompt sentence includes at least the following elements: (i) a representation of the customer inquiry; (ii) a representation of the inferred intention; (iii) a representation of the inferred emotional state; (iv) a representation of the technical summary describing abnormal events or system states; and (v) constraints on style and explanation granularity. For example, the server may generate a prompt sentence such as:

“Customer inquiry: ‘I cannot log in to my account and I am very worried.’

Intent: login problem.

Detected emotion: anxious.

Technical context: recent abnormal login failures detected for this account from multiple locations within the last 10 minutes.

Task: As a support system, generate a clear and calm response that (1) acknowledges the customer's concern, (2) explains that suspicious access attempts were detected, (3) instructs the customer how to reset the password securely, and (4) reassures the customer that unauthorized charges will be prevented.”

In another example related to delivery delay, the server may generate a prompt sentence such as:

“Customer inquiry: ‘The product I ordered has not arrived yet. What should I do?’ Intent: delivery delay.

Detected emotion: anxious.

Technical context: shipment status indicates delay due to regional logistics issues; exact arrival time is uncertain.

Task: Generate a polite and reassuring response that (1) apologizes for the delay, (2) explains that the shipment is in transit, (3) instructs the customer how to check tracking information, and (4) offers further assistance if the package does not arrive by a recommended date.”

For an internal operator, the server may generate a prompt sentence such as:

“Incident summary: abnormal login pattern detected for multiple accounts from network segment A, including 12 failed login attempts per account within 60 seconds.

Task: Generate a concise technical explanation for an operator that (1) lists possible causes, (2) recommends immediate actions such as blocking the source network and forcing password reset, and (3) identifies metrics and logs that should be monitored in the next hour.” The server inputs the prompt sentence to a generative AI model. The generative AI model is implemented as a neural-network-based language model trained on large amounts of textual data. The server interacts with the model via an inference API that receives the prompt sentence and returns a generated text. The server may specify generation parameters such as maximum token length, sampling temperature, or top-k selection thresholds. The server obtains response information from the generative AI model as an output sequence of tokens, which the server converts into text and post-processes.

The server adjusts the expression content and the level of detail of the response information in accordance with the emotional state and a predetermined response policy. The server may implement rules for mapping emotion categories and intensities to style conditions and explanation granularity conditions. For example, for an anger category with high intensity, the server enforces that the response information includes an apology expression at the beginning and limits technical jargon. For a confusion category, the server increases the explanation granularity by requiring step-by-step procedural explanation expressions. The server may parse the initial response information and insert or modify textual segments to satisfy these conditions. The server thus generates user-oriented response information with stylistic and structural adjustments, and operator-oriented response information with technical emphasis and minimal emotional adjustment.

The terminal receives the response information from the server and performs display control. The terminal may render user-oriented response information in a chat interface or a notification view, showing apology expressions, reassurance expressions, and clear procedures. The terminal may render operator-oriented response information in an administrative console, including technical summaries, metric references, and recommended commands or configuration changes. The terminal may also provide interface elements through which the user or the operator can indicate whether the response solved the problem, request more detail, or express satisfaction or dissatisfaction.

The user interacts with the terminal to provide reaction information. For example, the user may submit a follow-up inquiry such as “I followed the steps but still cannot log in,” which the server stores as new inquiry information linked to the prior response information. The user may also provide explicit ratings or select options indicating that the response was helpful or not helpful. The terminal transmits such feedback to the server as reaction information. The server stores the reaction information and associates it with the corresponding inquiry information, record information, and response information.

The server executes learning processing using the stored correspondences and reaction information. The server may update parameters used in analysis processing, such as thresholds for abnormality degrees, weights in emotion classification models, or mapping rules from emotion labels to style conditions. The server may also adapt prompt construction patterns; for example, if a particular pattern of prompt sentence yields higher user satisfaction, the server increases its usage frequency, whereas patterns associated with negative reactions are adjusted or deprecated. The server may retrain component models periodically, using reaction information as labels indicating whether earlier responses were adequate.

By storing structured record information, using feature vectors representing time-correlated metrics, and employing trained abnormality detection models, the server achieves higher detection accuracy of abnormal events compared with simple rule-based approaches. The use of autoencoders and continuous retraining on evolving behavior patterns allows the server to adapt to new normal conditions and detect subtle anomalies that manual threshold settings might miss. This improves the precision and recall of abnormal event detection, reducing false positives and false negatives.

The integration of intent and emotion identification with technical summaries into the prompt sentence allows the server to control the generative AI model in a non-trivial manner. Instead of manually written templates or loosely specified prompts, the server constructs prompt sentences from machine-derived structured data. This reduces variability in generative outputs, increases the consistency between detected system states and explanations, and prevents common failure modes in generative models such as hallucination or contradiction with system logs. Because the prompt sentence carries explicit constraints, the generative AI model is less likely to generate irrelevant or unhelpful responses.

The use of emotion-aware style and detail control improves computational efficiency and reduces overall communication load. By tailoring the level of detail and tone to the emotional state, the server reduces the number of follow-up inquiries needed to resolve a problem. Fewer iterations mean fewer messages transmitted over the network and fewer invocations of computationally intensive generative AI model inference, thus reducing processing time and resource consumption. Furthermore, aligning explanation granularity with a user's comprehension level reduces misunderstandings that might otherwise lead to repeated expensive checks or escalations.

The server, by combining anomaly detection, natural language processing, and generative modeling into a unified architecture, improves the functioning of the computer system itself. The server transforms low-level record information and user inquiries into structured intermediate representations, uses those representations to drive model inference under explicit constraints, and uses feedback signals to refine that process. This is not mere automation of human tasks; the server performs computations that humans cannot practically perform at scale, such as continuous evaluation of high-dimensional feature vectors for tens of thousands of time windows, dynamic mapping from emotional and technical contexts to parameterized generation constraints, and systematic tracking of long-term patterns in user reactions. The overall architecture thereby achieves increased processing throughput, improved detection and explanation accuracy, and reduced latency in delivering appropriate responses.

Alternative embodiments are possible. The server may use different neural network architectures for abnormality detection, such as recurrent neural networks for sequential data, convolutional neural networks for certain time-series encodings, or transformer-based encoders. The server may use different natural language processing pipelines, such as rule-based segmenters, statistical parsers, or transformer-based encoders. The generative AI model may be a sequence-to-sequence model, a decoder-only language model, or a modular architecture. The feature sets for abnormality detection may incorporate additional metrics, such as aggregated error counts, resource consumption distributions, or inter-event timing patterns.

In other embodiments, the terminal performs a portion of the analysis processing. For example, the terminal may execute a lightweight emotion classification model to compute a preliminary emotional state that is transmitted along with inquiry information. This can reduce server-side processing load and allow faster adaptation of style conditions. The server can still recompute or refine the emotional state if necessary, but the preliminary classification can be used as a strong prior.

In another variation, the server uses a rule-based or hybrid approach for style and detail adjustment, combining learned mappings from emotion labels to style conditions with explicit rules defined by system administrators. For example, the server may always insert a specific safety warning phrase when explaining security-related abnormal events, regardless of emotion. This hybrid design allows the system to comply with regulatory or policy constraints while benefiting from the adaptability of machine learning.

By structuring data as record information, intermediate representations (intent, emotional state, technical summary, style condition, explanation granularity condition), prompt sentences, and response information, and by implementing explicit computational modules for each transformation between these representations, the server provides a concrete and reproducible mechanism for controlling interactions with a generative AI model. The cooperation between the server, the terminals, and the users, supported by these modules, yields technical effects such as improved computational efficiency, enhanced anomaly detection and explanation quality, and reduced network and processing overhead for resolving incidents and user inquiries.

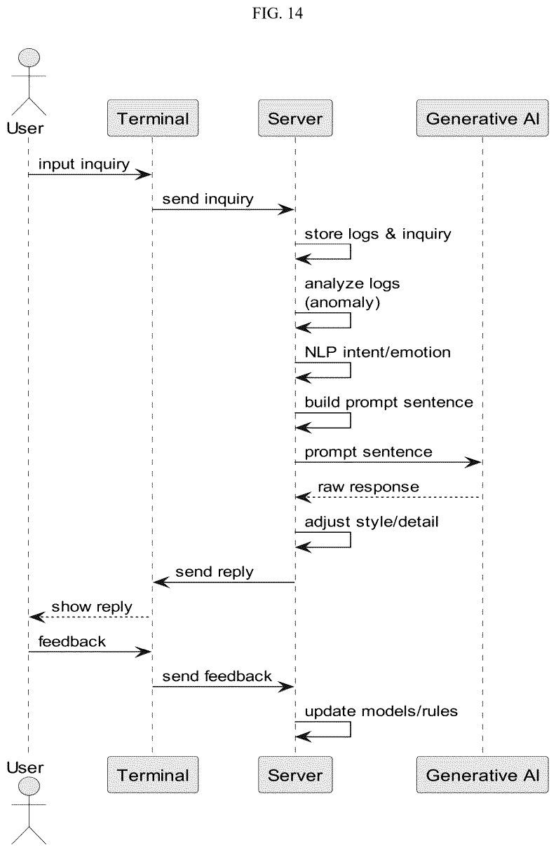

The following describes the processing flow using FIG. 14.

### Step 1:

Server acquires observation information from sensors and log-producing components.

Server receives, as input, raw data streams such as sensor signals and log lines containing timestamps, component identifiers, event types, and status codes. Server parses each input element using predefined parsing rules, splits the raw strings into fields, converts data types (for example, string timestamps into numerical time representations), and discards irrelevant tokens. Server outputs structured tuples representing record information, including normalized fields such as time, source, event category, and metric values.

### Step 2:

Server stores record information in structured data stores.

Server receives, as input, the structured tuples from Step 1. Server maps the tuples to database schemas, assigns primary keys, and inserts the records into relational tables or time-series structures. Server applies indexing on fields such as time, source, and event category, and may partition the data by time ranges. Server outputs stored record information that can be efficiently queried and aggregated for later analysis.

### Step 3:

Terminal transmits inquiry information from the user to the server.

User enters, as input, natural language text such as a complaint, question, or report into an input field on the terminal and triggers a send operation. Terminal packages the text together with metadata including user identifiers, device identifiers, language information, and timestamps into a message. Terminal sends this message through a network interface to the server. Terminal outputs a formatted request containing the inquiry information and metadata.

### Step 4:

Server stores inquiry information and associates it with record information.

Server receives, as input, the formatted request from the terminal containing the inquiry text and metadata. Server writes the inquiry text, user identifiers, timestamps, and an initial processing status into an inquiry table. Server queries the record information store for recent entries related to the same user identifiers or devices, using time windows and filters, and links identifiers between the inquiry record and relevant record information. Server outputs an updated database state with stored inquiry records and their associations to record information.

### Step 5:

Server generates feature vectors from record information for abnormality detection.

Server receives, as input, sets of record information selected by time windows and identifiers associated with active users or systems. Server aggregates counts of specific event categories, computes statistical measures such as averages and variances of metrics, and generates fixed-length numerical vectors representing behavior during each time window. Server normalizes the vectors by scaling or centering values according to training-time statistics. Server outputs feature vectors suitable for input to an abnormality detection model.

### Step 6:

Server evaluates abnormality degrees using an abnormality detection model.

Server receives, as input, the feature vectors from Step 5. Server loads parameters of a trained abnormality detection model, such as an autoencoder, and performs forward passes through the neural network, computing reconstructed feature vectors and intermediate activations. Server computes reconstruction errors or other anomaly scores by subtracting reconstructed outputs from the inputs and calculating norms or loss values. Server compares the scores to thresholds and outputs abnormality degrees and flags indicating whether each time window or context is abnormal.

### Step 7:

Server generates technical summaries for abnormal events.

Server receives, as input, abnormality flags, abnormality degrees, and the underlying record information segments used to compute them. Server selects record entries with scores exceeding thresholds, groups them by identifiers, and extracts salient attributes such as error codes, frequencies, and affected components. Server composes a concise technical summary text that describes what abnormal pattern occurred, when it occurred, and which components were involved. Server outputs technical summaries and links them to corresponding abnormal event identifiers.

### Step 8:

Server performs natural language preprocessing of inquiry information.

Server receives, as input, inquiry text from Step 4. Server applies natural language processing functions, such as tokenization to split text into tokens, part-of-speech tagging to annotate grammatical categories, and named-entity recognition to detect entities like account identifiers or product types. Server may remove stop words or normalize tokens (for example, by lowercasing or stemming). Server outputs token sequences and annotated structures representing the linguistic content of the inquiry.

### Step 9:

Server infers user intention from the processed inquiry information.

Server receives, as input, token sequences and annotations from Step 8. Server converts tokens into numerical representations such as word or subword embeddings and feeds them into an intent classification model. Server computes activations layer by layer, applies a softmax function at the classification layer, and determines the most probable intention category (for example, login issue, payment issue, or delivery status query). Server outputs an intention label and associated confidence values.

### Step 10:

Server estimates an emotional state of the user.

Server receives, as input, the original inquiry text and optionally the tokenized representation from Step 8. Server applies an emotion estimation model that computes sentiment polarity and classifies the text into emotion categories such as anger, frustration, confusion, anxiety, or neutrality. Server uses learned parameters to compute probabilities for each category and determines a dominant emotional state and a numerical intensity measure. Server outputs an emotional state label and an intensity value linked to the inquiry.

### Step 11:

Server determines style conditions and explanation granularity conditions.

Server receives, as input, the emotional state from Step 10 and, optionally, the intention from Step 9. Server consults a rule set or a learned mapping that assigns style conditions and explanation granularity conditions based on emotion-intention pairs. For example, server sets a polite, apologetic style for high-intensity negative emotions and a detailed, step-by-step explanation level for confusion. Server outputs conditions specifying tone, formality, and amount of detail required for the response.

### Step 12:

Server selects relevant technical context for inclusion in the prompt sentence.

Server receives, as input, the technical summaries from Step 7 and the intention from Step 9. Server filters technical summaries to those associated with the same user or system context as the inquiry and ranks them by recency and severity. Server selects one or more summaries that explain conditions most relevant to the inferred intention. Server outputs a condensed technical context, including key metrics and explanations, to be embedded into a prompt sentence.

### Step 13:

Server constructs a prompt sentence for the generative AI model.

Server receives, as input, the inquiry text, intention label, emotional state, style conditions, explanation granularity conditions, and selected technical context. Server generates a structured textual instruction that includes: a quotation of the user inquiry, explicit labels for intent and emotion, a human-readable description of the technical context, and detailed instructions specifying how the generative AI model should respond. Server concatenates these components in a predefined template, ensuring that task requirements and constraints are clearly encoded. Server outputs the completed prompt sentence as a text string.

### Step 14:

Server invokes the generative AI model with the constructed prompt sentence.

Server receives, as input, the prompt sentence from Step 13. Server transmits the prompt sentence to an inference interface of the generative AI model, together with generation parameters such as maximum length and sampling settings. Inside the model, server-side processing converts the text into token identifiers, passes them through multiple network layers, and generates a sequence of output token probabilities step by step. Server decodes the tokens into a natural language response and receives the resulting text as output. Server outputs raw response information generated by the generative AI model.

### Step 15:

Server adjusts expression content and level of detail in the response information.

Server receives, as input, the raw response information from Step 14, along with the emotional state and style and granularity conditions from Step 11. Server analyzes the response text to detect the presence of required elements such as apology expressions, reassurance expressions, and procedural explanation expressions. If required elements are missing or insufficient, server programmatically inserts or modifies sentences to satisfy the conditions. Server may truncate overly long parts or add clarifying steps to match the desired level of detail. Server outputs adjusted user-oriented response information and, if needed, a separate operator-oriented version containing more technical details and fewer emotional adjustments.

### Step 16:

Server transmits response information to terminals.

Server receives, as input, the user-oriented and operator-oriented response information from Step 15 together with destination identifiers. Server packages the responses into network messages, possibly with additional metadata such as timestamps and response identifiers. Server sends the messages via the network interface to terminals associated with users and operators. Server outputs delivered response payloads ready for display at each terminal.

### Step 17:

Terminal performs display control based on received response information.

Terminal receives, as input, the response payload from Step 16. Terminal interprets metadata to decide how and where to present the response, such as in a chat window, a notification banner, or an administrative console. Terminal renders text with appropriate fonts and layouts, optionally highlighting key instructions or warnings. Terminal outputs a visual presentation of the response on a display unit for the user or the operator.

### Step 18:

User reacts to the displayed response and submits reaction information.

User views, as input, the response displayed by the terminal in Step 17. User decides whether the response is satisfactory and may perform suggested steps or request additional clarification. User indicates a reaction, such as pressing a “This solved my problem” button, entering a follow-up question, or selecting a satisfaction rating. Terminal captures this reaction as reaction information and sends it to the server. Terminal outputs a message containing reaction data associated with the corresponding inquiry and response.

### Step 19:

Server stores correspondence and reaction information.

Server receives, as input, the reaction information from Step 18. Server links the reaction to the original inquiry information, the record information used for analysis, and the response information that was presented. Server updates database entries to record outcome statuses, such as resolved or unresolved, and stores numeric or categorical feedback where available. Server outputs an updated knowledge base of interaction records with labeled outcomes.

### Step 20:

Server updates analysis processing and prompt construction based on accumulated data.

Server receives, as input, historical correspondences and reaction records from Step 19. Server computes performance metrics for previous responses, such as resolution rates for specific model settings or prompt patterns. Server applies optimization algorithms or retraining procedures to refine parameters of abnormality detection models, intent and emotion classifiers, and mappings from emotions to style conditions. Server also modifies templates and composition rules used in constructing prompt sentences to favor structures correlated with successful outcomes. Server outputs updated model parameters, rule sets, and templates, thereby improving future analysis processing and prompt sentence generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

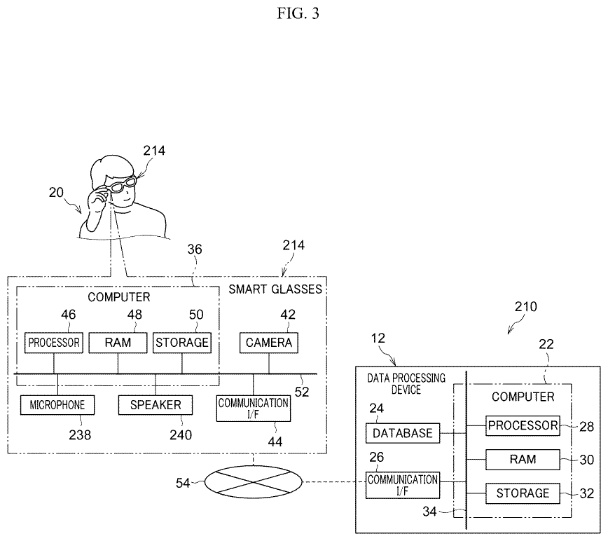

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

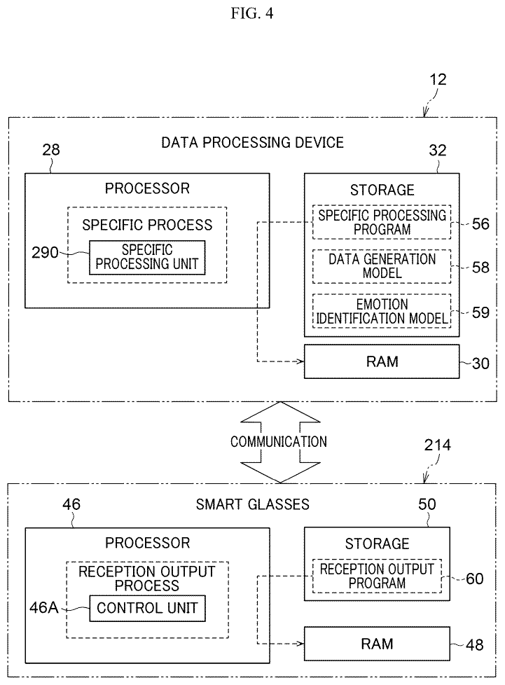

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

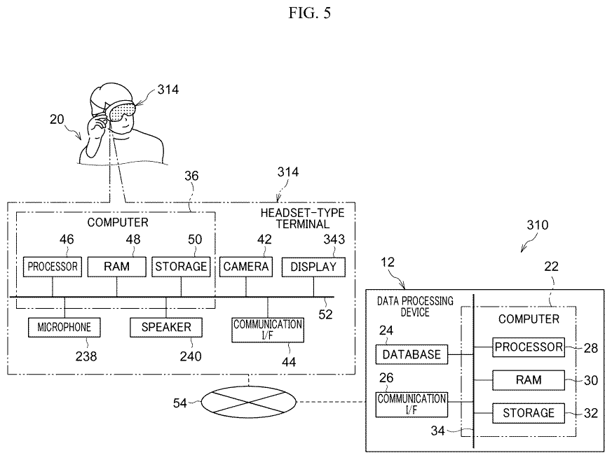

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

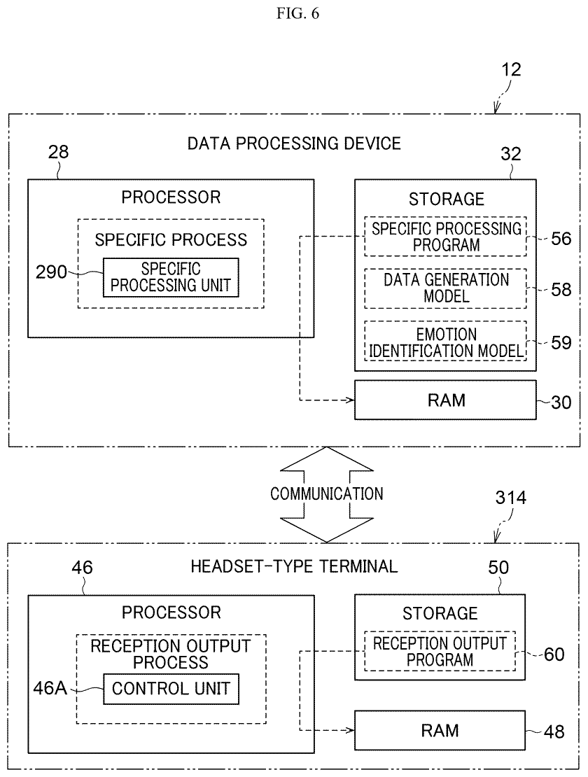

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

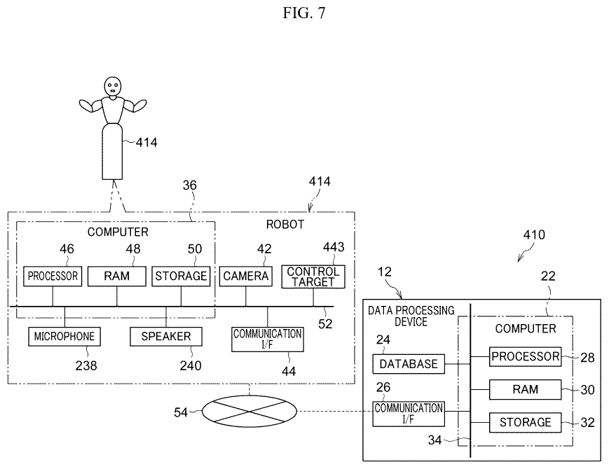

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

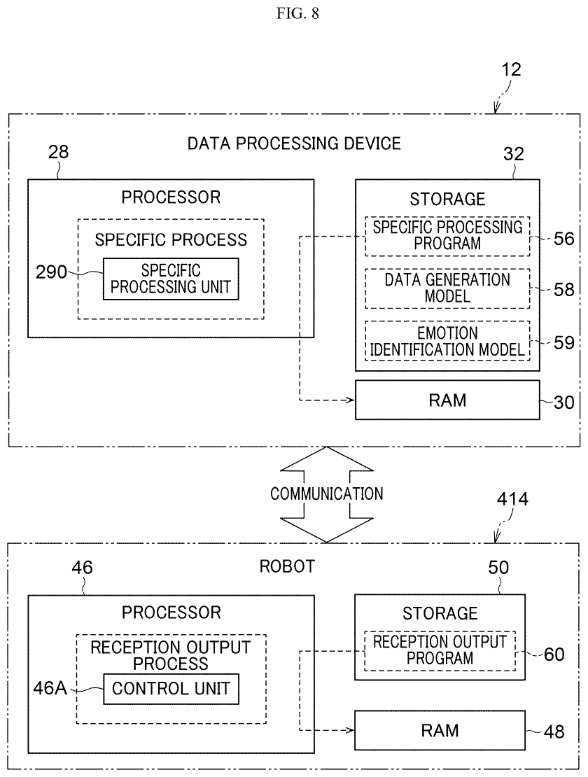

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

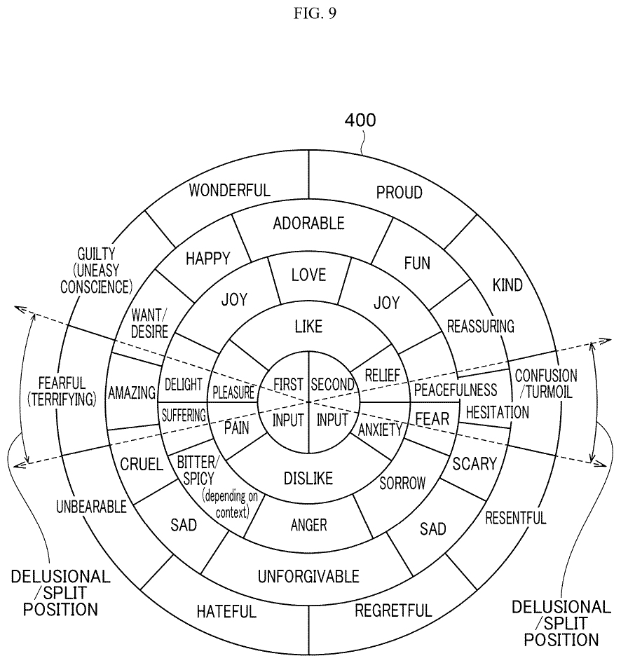

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

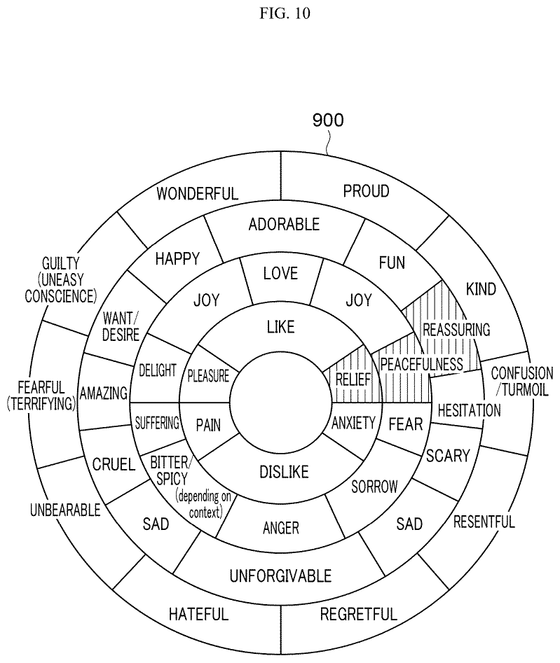

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to monitor operation information including observation information and transaction information acquired in an information processing apparatus,
generate statistical information and event information from the operation information, and
detect an abnormal event based on the statistical information and the event information,
wherein the processor is configured to generate a first prompt sentence for instructing a generative artificial intelligence model to generate summary information and hypothesis information regarding the abnormal event using a detection result of the abnormal event and the operation information as input information, and to control the generative artificial intelligence model to generate explanation information regarding the abnormal event based on the generated first prompt sentence,
wherein the processor is configured to analyze inquiry information in natural language acquired from a user apparatus via a communication apparatus by using a language processing algorithm, extract inquiry intention information and urgency information, generate a response generation prompt sentence including the inquiry information, the inquiry intention information, and the urgency information, and control the generative artificial intelligence model to generate user response information based on the generated response generation prompt sentence,
wherein the processor is configured to acquire related rule information and guidance information from a knowledge information storage apparatus according to the inquiry intention information and the urgency information, and add the acquired rule information and guidance information to the response generation prompt sentence,
wherein the processor is configured to generate and transmit notification information to a staff apparatus based on the detection result of the abnormal event, and to distribute the explanation information and the user response information generated by the generative artificial intelligence model to the staff apparatus and the user apparatus, respectively,
wherein the processor is configured to aggregate the operation information and the explanation information regarding past abnormal events, generate a report generation prompt sentence for input to the generative artificial intelligence model, and control the generative artificial intelligence model to generate report information including recurrence prevention measure information based on the generated report generation prompt sentence, and
wherein the processor is configured to acquire evaluation information regarding the inquiry information, the user response information, and the report information, and update contents of the first prompt sentence and the response generation prompt sentence based on the evaluation information.

### (Supplementary 2)

The system according to supplementary 1,
wherein the processor is configured to generate time-series information by aggregating the operation information along a time axis, generate integrated information by integrating a plurality of types of the operation information acquired from a plurality of recording sources, generate an analysis prompt sentence including the time-series information and the integrated information, input the analysis prompt sentence to the generative artificial intelligence model to acquire analysis result information including cause candidate information and influence range information regarding the abnormal event, and reflect the analysis result information in the explanation information and the report information.

### (Supplementary 3)

The system according to supplementary 1,
wherein the processor is configured to generate a dialogue prompt sentence for input to the generative artificial intelligence model by selecting, according to operation information input from the user apparatus, at least one of the inquiry information and the explanation information related to the abnormal event, and to cause the user apparatus to display dialogue response information generated based on the dialogue prompt sentence, thereby enabling the user to perform dialogue support for making additional inquiries to the generative artificial intelligence model regarding the abnormal event and the inquiry information.

### Application Example 1

### (Supplementary 1)

A system comprising a processor,
wherein the processor is configured to
monitor log information including operation information acquired from an information source when an abnormal event occurs, and determine whether the abnormal event has occurred based on the log information, and
analyze natural language information including an inquiry content of a user acquired from an information processing terminal inside the system, and identify an intention and classification information of the inquiry content, and
generate a prompt sentence for instructing a generative information processing apparatus to generate response information, based on the inquiry content and the intention or the classification information, and
control the generative information processing apparatus such that the generative information processing apparatus generates the response information based on the prompt sentence and the log information, and
transmit the response information generated by the generative information processing apparatus to the information processing terminal, and cause the information processing terminal to present the response information to the user, and
analyze the log information, identify candidate causes and candidate countermeasures of the abnormal event, and generate analysis result information including the candidate causes and the candidate countermeasures, and
automatically generate notification information to be transmitted to a related party and transmit the notification information, based on the analysis result information or the log information, when occurrence of the abnormal event is detected.

### (Supplementary 2)

The system according to supplementary 1,
wherein the processor is configured to
input feature values extracted from the log information to a learned inference model, calculate an abnormality degree by the learned inference model, determine occurrence of the abnormal event based on the abnormality degree, and, when occurrence of the abnormal event is determined, generate and transmit the notification information.

### (Supplementary 3)

The system according to supplementary 1,
wherein the processor is configured to
aggregate log information related to the abnormal event, generate statistical information and summary information, generate a prompt sentence for instructing the generative information processing apparatus to generate a root cause and a countermeasure plan based on analysis input information including the statistical information and the summary information, and output the root cause and the countermeasure plan generated by the generative information processing apparatus as the analysis result information.

### Example 2

### (Supplementary 1)

A system comprising a processor,
wherein the processor is configured to
acquire and aggregate time-series sensor data and log data; and convert the aggregated data into a format processable by a machine learning process, and perform data formatting, normalization, and feature extraction on the aggregated data; and
construct and store a trained discrimination model for identifying normal patterns and abnormal patterns based on past event data; and
calculate an abnormality degree for newly input data by using the trained discrimination model, and automatically detect an abnormal event by comparing the abnormality degree with a threshold; and
generate, when the abnormal event is detected, a prompt sentence for instructing a generative AI model to generate notification content, the prompt sentence being automatically generated on the basis of structured information including an occurrence time of the abnormal event, an impact range, related indices, and summary information; and
input the prompt sentence and the structured information into the generative AI model and cause the generative AI model to generate a notification message in natural language; and convert the generated notification message into a message format corresponding to a notification channel, and perform delivery control to transmit the notification message to a user terminal; and
acquire response operation information from the user terminal, associate the response operation information with the abnormal event and the notification message, and store the response operation information as learning data usable for improvement of the trained discrimination model or a generation logic of the prompt sentence.

### (Supplementary 2)

The system according to supplementary 1,
wherein the processor is configured to
generate a plurality of kinds of the prompt sentence in accordance with a type of the abnormal event and an attribute of a notification target, cause the generative AI model to generate notification messages by using the plurality of kinds of the prompt sentence, and control distribution so that notification messages having different expressions and levels of detail are delivered for respective notification channels.

### (Supplementary 3)

The system according to supplementary 1,
wherein the processor is configured to
after distribution of the notification message, acquire, as the response operation information, at least one of a confirmation operation, an additional inquiry operation, and a completion-of-response operation performed by a user, and automatically update the threshold for abnormality detection and generation rules for the prompt sentence on the basis of a relationship between the response operation information and the abnormality degree, the prompt sentence, and the notification message.

### Application Example 2

### (Supplementary 1)

A system comprising a processor,
wherein the processor is configured to acquire observation information related to an abnormal event and store the observation information as record information,
wherein the processor is configured to perform analysis processing using natural language processing and machine learning on the record information and on inquiry information acquired from a user, to identify an intention of the inquiry information and an emotional state of the user, and to identify, based on the record information, presence or absence of the abnormal event and a technical summary related to the abnormal event,
wherein the processor is configured to construct a prompt sentence for input to a generative AI model based on the intention, the emotional state, and the technical summary, and to instruct the generative AI model to execute response generation processing in accordance with the prompt sentence,
wherein the processor is configured to adjust an expression content and a level of detail of response information obtained from the generative AI model in accordance with the emotional state and a predetermined response policy, and to generate user-oriented response information and operator-oriented response information,
wherein the processor is configured to transmit the user-oriented response information and the operator-oriented response information as notification information to a communication terminal and to cause the communication terminal to perform display control, and wherein the processor is configured to store a correspondence between the inquiry information and the response information and reaction information from the user with respect to the response information, and to execute learning processing for updating the prompt sentence and processing conditions of the analysis processing.

### (Supplementary 2)

The system according to supplementary 1,
wherein the processor is configured to store, as the record information, operation history
information indicating an operation state and detection information acquired from a monitoring device in association with time information, to evaluate the record information successively by using an abnormality detection model that has learned an abnormal pattern by a statistical learning method or a deep learning method as the analysis processing, to generate the technical summary when an abnormality degree exceeds a predetermined threshold, and to cause the generative AI model to generate, as the operator-oriented response information, an explanatory sentence including an initial response plan and an index to be monitored.

### (Supplementary 3)

The system according to supplementary 1,
wherein the processor is configured to estimate, as the emotional state, an emotion category and an emotion intensity derived from utterance content of the user, to generate the prompt sentence including a style condition and an explanation granularity condition corresponding to the emotion category and the emotion intensity, and to generate the user-oriented response information by adding or changing at least one of a gratitude expression, an apology expression, a reassurance expression, and a procedural explanation expression in the response information obtained from the generative AI model in accordance with the emotional state.

What is claimed is:

1. A system comprising:
circuitry configured to:
monitor operation information comprising sensor data and log data acquired from an information processing apparatus via a packet-switched network, generate statistical information and event information from the operation information, and detect an abnormal event based on the statistical information and the event information;
generate a first prompt sentence for a generative neural network model based on a detection result of the abnormal event and the operation information, and cause the generative neural network model to generate explanation information comprising summary information and hypothesis information regarding the abnormal event;
receive inquiry information in natural language from a client terminal via the packet-switched network, analyze the inquiry information using a language processing algorithm to extract intent information and urgency information, and generate a response prompt sentence based on the inquiry information, the intent information, and the urgency information;
cause the generative neural network model to generate response information based on the response prompt sentence; and
transmit the explanation information and the response information to at least one of the client terminal and a staff terminal via the packet-switched network.

2. The system according to claim 1, wherein the circuitry is configured to monitor the operation information in real time by acquiring the sensor data and the log data at periodic intervals, compute time-series statistical features comprising moving averages, variance values, and rate-of-change values from the sensor data and the log data, and detect the abnormal event when at least one of the time-series statistical features deviates from a baseline threshold.

3. The system according to claim 2, wherein the circuitry is configured to construct a trained discrimination model by processing past event data to identify normal patterns and abnormal patterns, calculate an abnormality degree for newly acquired operation information using the trained discrimination model, and detect the abnormal event when the abnormality degree exceeds the baseline threshold.

4. The system according to claim 3, wherein the circuitry is configured to generate integrated information by aggregating a plurality of types of the operation information acquired from a plurality of recording sources along a time axis, generate an analysis prompt sentence including the integrated information and the abnormality degree, and input the analysis prompt sentence to the generative neural network model to obtain analysis result information comprising cause candidate information and influence range information regarding the abnormal event.

5. The system according to claim 4, wherein the circuitry is configured to incorporate the cause candidate information and the influence range information into the first prompt sentence, and cause the generative neural network model to generate the explanation information with enhanced specificity based on the incorporated analysis result information.

6. The system according to claim 1, wherein the circuitry is configured to acquire rule information and guidance information from a knowledge information storage apparatus based on the intent information and the urgency information, and append the rule information and the guidance information to the response prompt sentence prior to causing the generative neural network model to generate the response information.

7. The system according to claim 6, wherein the circuitry is configured to select the rule information from the knowledge information storage apparatus by matching the intent information against stored rule categories, and to assign a priority level to the response prompt sentence based on the urgency information such that response information generated for high-urgency inquiries includes specific remediation steps.

8. The system according to claim 7, wherein the circuitry is configured to generate a dialogue prompt sentence based on follow-up inquiry information received from the client terminal and the previously generated response information, and cause the generative neural network model to generate supplementary response information enabling multi-turn dialogue support regarding the abnormal event.

9. The system according to claim 1, wherein the circuitry is configured to generate notification information based on the detection result of the abnormal event, transmit the notification information to the staff terminal via the packet-switched network, and distribute the explanation information generated by the generative neural network model to the staff terminal together with structured event metadata comprising an occurrence time, an impact range, and a severity classification.

10. The system according to claim 9, wherein the circuitry is configured to determine a notification routing based on the severity classification by matching the severity classification against a routing table associating severity levels with designated staff terminals, and to escalate the notification information to additional staff terminals when the severity classification exceeds a predefined escalation threshold.

11. The system according to claim 10, wherein the circuitry is configured to track acknowledgment data received from the staff terminals in response to the notification information, detect when acknowledgment data has not been received within a specified time period, and transmit a re-notification to the designated staff terminals or escalate to a higher-level staff terminal.

12. The system according to claim 1, wherein the circuitry is configured to aggregate the operation information and the explanation information regarding past abnormal events stored in a storage medium, generate a report generation prompt sentence for the generative neural network model based on the aggregated information, and cause the generative neural network model to generate report information comprising recurrence prevention measure information and trend analysis information.

13. The system according to claim 12, wherein the circuitry is configured to extract pattern information from a plurality of past abnormal events by comparing cause candidate information across the plurality of events, identify recurring fault patterns, and include the recurring fault patterns in the report generation prompt sentence to instruct the generative neural network model to generate targeted prevention recommendations.

14. The system according to claim 13, wherein the circuitry is configured to generate a structured report document comprising the trend analysis information, the recurring fault patterns, and the targeted prevention recommendations, and to transmit the structured report document to the staff terminal via the packet-switched network on a periodic schedule.

15. The system according to claim 1, wherein the circuitry is configured to acquire evaluation information comprising user satisfaction scores and resolution outcome data regarding the response information, and update at least one of the first prompt sentence and the response prompt sentence based on the evaluation information to improve quality of subsequently generated explanation information and response information.

16. The system according to claim 15, wherein the circuitry is configured to compare the evaluation information against historical evaluation data to identify prompt components associated with high-quality responses, and to preferentially retain the identified prompt components in subsequently generated prompt sentences.

17. The system according to claim 1, wherein the circuitry is configured to estimate an emotional state of the user based on linguistic features extracted from the inquiry information, and to adjust a tone and detail level of the response information generated by the generative neural network model based on the estimated emotional state.

18. A system comprising:
circuitry configured to:
monitor operation information comprising sensor data and log data acquired via a packet-switched network, and detect an abnormal event based on statistical analysis of the operation information;
generate a first prompt sentence for a generative neural network model based on a detection result of the abnormal event;
cause the generative neural network model to generate explanation information regarding the abnormal event;
receive inquiry information in natural language from a client terminal via the packet-switched network;
analyze the inquiry information using a language processing algorithm to extract intent information and urgency information;
generate a response prompt sentence based on the inquiry information, the intent information, and the urgency information;
cause the generative neural network model to generate response information based on the response prompt sentence;
estimate an emotional state of a user based on the inquiry information and adjust a tone of the response information based on the estimated emotional state; and
transmit the response information to the client terminal via the packet-switched network.

19. The system according to claim 18, wherein the circuitry is configured to aggregate the operation information and the explanation information regarding past abnormal events, generate a report generation prompt sentence, and cause the generative neural network model to generate report information comprising recurrence prevention measure information.

20. A method performed by circuitry, the method comprising:
monitoring operation information comprising sensor data and log data acquired via a packet-switched network, and detecting an abnormal event based on statistical analysis of the operation information;
generating a first prompt sentence for a generative neural network model based on a detection result of the abnormal event;
causing the generative neural network model to generate explanation information regarding the abnormal event;
receiving inquiry information in natural language from a client terminal via the packet-switched network;
analyzing the inquiry information using a language processing algorithm to extract intent information and urgency information;
generating a response prompt sentence based on the inquiry information, the intent information, and the urgency information;
causing the generative neural network model to generate response information based on the response prompt sentence; and
transmitting the response information to the client terminal via the packet-switched network.
